(19) United States
(12) Patent Application Publication
(10) Pub. No.: US 2025/0321406 A1
(43) Pub. Date: Oct. 16, 2025

(54) FLAT OPTICS CAMERA MODULE FOR HIGH QUALITY IMAGING

(71) Applicant: Taiwan Semiconductor Manufacturing Company, Ltd., Hsinchu (TW)

(72) Inventors: Jung-Huei Peng, Jhubei City (TW); Chun-Wen Cheng, Zhubei City (TW); Yi-Chien Wu, Taichung City (TW); Tsun-Hsu Chen, Hsinchu City (TW)

(21) Appl. No.: 19/248,547

(22) Filed: Jun. 25, 2025

Related U.S. Application Data
(63) Continuation of application No. 18/313,459, filed on May 8, 2023.
(60) Provisional application No. 63/405,972, filed on Sep. 13, 2022.

(51) Int. Cl. G02B 13/18; G02B 7/02; G02B 27/10

(52) U.S. Cl. CPC G02B 13/18; G02B 7/021; G02B 27/1013

(57) ABSTRACT

Various embodiments of the present disclosure are directed towards a camera module comprising flat lenses. Flat lenses have reduced thicknesses compared to other types of lenses, whereby the camera module may have a small size and camera bumps may be omitted or reduced in size on cell phones and the like incorporating the camera module. The flat lenses are configured to focus visible light into a beam of white light, split the beam into sub-beams of red, green, and blue light, and guide the sub-beams respectively to separate image sensors for red, green, and blue light. The image sensors generate images for corresponding colors and the images are combined into a full-color image. Optically splitting the beam into the sub-beams and using separate image sensors for the sub-beams allows color filters to be omitted and smaller pixel sensors. This, in turn, allows higher quality imaging.

### REFERENCE TO RELATED APPLICATIONS

This Application is a Continuation of U.S. application Ser. No. 18/313,459, filed on May 8, 2023, which claims the benefit of U.S. Provisional Application No. 63/405,972, filed on Sep. 13, 2022. The contents of the above-referenced Patent Applications are hereby incorporated by reference in their entirety.

### BACKGROUND

Integrated circuits (ICs) with image sensors are used in a wide range of modern-day electronic devices, such as, for example, cameras, cell phones, and the like. Types of image sensors include, for example, complementary metal-oxide semiconductor (CMOS) image sensors and charge-coupled device (CCD) image sensors. Compared to CCD image sensors, CMOS image sensors are increasingly favored due to low power consumption, small size, fast data processing, a direct output of data, and low manufacturing cost.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates a schematic view of some embodiments of a camera module comprising flat lenses.

FIGS. 2A-2C illustrate schematic views of some alternative embodiments of the camera module of FIG. 1.

FIG. 3 illustrates a cross-sectional view of some embodiments of a flat lens of FIG. 1.

FIG. 4 illustrates a cross-sectional view of some embodiments of the flat lens of FIG. 3 in which the flat lens is an imaging lens.

FIG. 5 illustrates a top layout view of some embodiments of the imaging lens of FIG. 4.

FIG. 6 illustrates a cross-sectional view of some alternative embodiments of the imaging lens of FIG. 4.

FIG. 7 illustrates a cross-sectional view of some embodiments of the flat lens of FIG. 3 in which the flat lens is a beam splitter.

FIG. 8 illustrates a top layout view of some embodiments of the beam splitter of FIG. 7.

FIG. 9 illustrates a perspective view of some embodiments of the beam splitter of FIGS. 7 and 8.

FIG. 10 illustrates a cross-sectional view of some alternative embodiments of the beam splitter of FIG. 7.

FIG. 11 illustrates a cross-sectional view of some embodiments of the flat lens of FIG. 3 in which the flat lens is a first beam deflector.

FIGS. 12A and 12B illustrate top layout views of some embodiments of the first beam deflector of FIG. 11.

FIG. 13 illustrates a perspective view of some embodiments of the first beam deflector of FIGS. 11 and 12B.

FIG. 14 illustrates a cross-sectional view of some alternative embodiments of the first beam deflector of FIG. 11.

FIG. 15 illustrates a cross-sectional view of some embodiments of the flat lens of FIG. 3 in which the flat lens is a second beam deflector.

FIG. 16 illustrates a cross-sectional view of some embodiments of an image sensor.

FIG. 17 illustrates a cross-sectional view of some embodiments of plurality of image sensors.

FIGS. 18A and 18B illustrate top layout views of some embodiments of the plurality of image sensors of FIG. 17.

FIG. 19 illustrates a cross-sectional view of some embodiments of the camera module of FIG. 1.

FIG. 20 illustrates a perspective view of some embodiments of the camera module of FIG. 19.

FIGS. 21A-21G illustrate cross-sectional views of some alternative embodiments of the camera module of FIG. 19.

FIGS. 22-24 illustrate a series of cross-sectional views of some embodiments of a method for forming a single-layer optical structure comprising a flat lens.

FIGS. 25-27 illustrate a series of cross-sectional views of some first embodiments of a method for forming a multi-layer optical structure comprising flat lenses.

FIGS. 28-31 illustrate a series of cross-sectional views of some second embodiments of a method for forming a multi-layer optical structure comprising flat lenses.

FIGS. 32-44 illustrate a series of cross-sectional views of some embodiments of a method for forming a camera module comprising flat lenses.

FIG. 45 illustrates a block diagram of some embodiments of the method of FIGS. 32-44.

### DETAILED DESCRIPTION

The present disclosure provides many different embodiments, or examples, for implementing different features of this disclosure. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Cells phones and the like often comprise camera modules. Such a camera module may comprise multiple curved, refractive lenses stacked over a complementary metal-oxide semiconductor (CMOS) image sensor (CIS). Further, the camera module may depend upon a large number of curved, refractive lenses (e.g., 6 or more) to achieve high image quality. However, curved, refractive lenses are thick, whereby the large number of curved, refractive lenses leads to a large camera module and a camera bump on cell phones and the like.

Further, the CIS depends on photodetectors that are color blind, whereby the CIS employs a Bayer color filter to achieve full color imaging. However, color filters block a portion of incident light, whereby the CIS has low efficiency and low sensitivity. Further, each full-color pixel sensor of the CIS comprises a group of four adjoining photodetectors. The four photodetectors are masked respectively by red, green, and blue color filters, and signals from the four photodetectors are combined into a full-color signal. As a result, full-color pixel sensors are large and the CIS has low spatial resolution and low color accuracy.

Various embodiments of the present disclosure are directed towards a camera module comprising flat lenses instead of curved, refractive lenses. In at least some embodiments, the flat lenses are meta lenses and/or use columnar structures having high refractive indexes and subwavelength sizes and/or spacings to manipulate light. Compared to curved, refractive lenses, flat lenses have reduced thicknesses. As such, the camera module may have a small size and camera bumps may be omitted or reduced in size on cell phones and the like.

In some embodiments, the flat lenses comprise an imaging lens, a plurality of beam deflectors, and a beam splitter between the imaging lens and the plurality of beam deflectors. The imaging lens is configured to focus incident light into a beam of white light. The beam splitter is configured to split the beam of white light into sub-beams of red, green, and blue light. The beam deflectors are configured to guide the sub-beams of red, green, and blue light respectively to separate CISs for red, green, and blue light. The CISs generate images for corresponding colors and the images are combined into a full-color image.

Because red, green, and blue light are split before reaching the CISs, each CIS only receives, or mostly only receives, one color of light. As such, color filters may be omitted from the CISs. By omitting color filters, the CISs may have high efficiency and high sensitivity. Further, because each CIS is used for only one color (e.g., red, green, or blue), no one CIS performs full-color imaging. Hence, pixel sensors of the CISs are smaller than full-color pixel sensors. The smaller pixel sensors lead to higher spatial resolution and enhanced color accuracy.

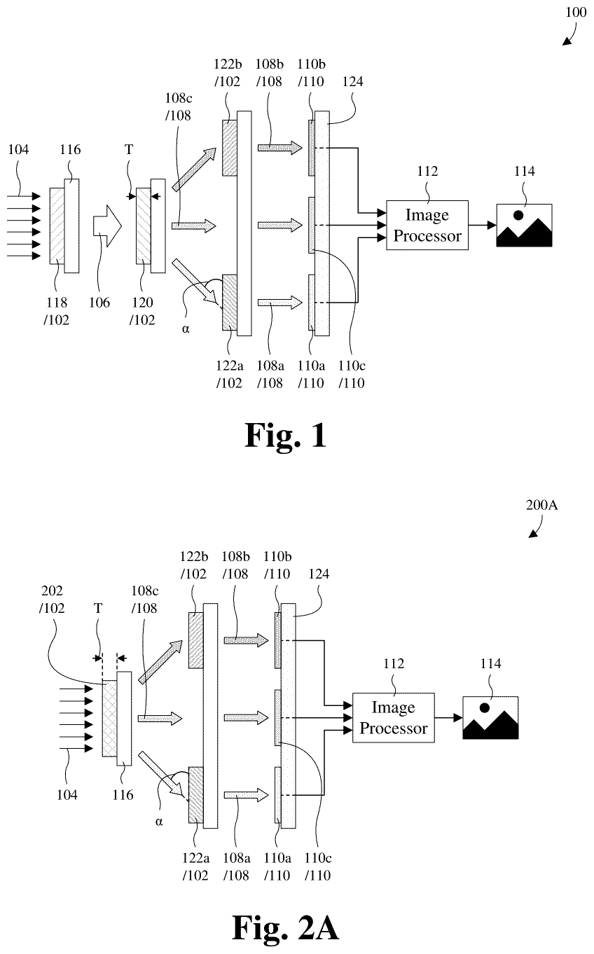

With reference to FIG. 1, a schematic view 100 of some embodiments of a camera module comprising a plurality of flat lenses 102 is provided. In some embodiments, the flat lenses 102 are meta lenses using columnar structures having high refractive indexes and subwavelength sizes and/or spacings to manipulate light. The high refractive indexes may, for example, be refractive indexes greater than about 2 or the like. In some embodiments, the flat lenses 102 may also be known as flat optics or flat optical structures.

The flat lenses 102 have planar or generally planar profiles. In other words, the flat lenses 102 have flat or generally flat top and bottom profiles. Further, the flat lenses 102 have thicknesses T that are less than thicknesses of curved, refractive lenses carrying out the same optical functions. Because of the lesser thicknesses T, the camera module may have a smaller size and camera bumps may be omitted or reduced in size on cell phones and the like in which the camera module is incorporated. The flat lenses 102 are configured to focus light 104 into a beam 106, to split the beam 106 into a plurality of sub-beams 108, and to guide the sub-beams 108 respectively to a plurality of image sensors 110. The beam 106 corresponds to visible or white light, whereas the sub-beams 108 correspond to red light, green light, and blue light.

The image sensors 110 are configured to generate individual images from the corresponding sub-beams 108. These images include a red image, a green image, and a blue image. Further, an image processor 112 is configured to combine the red, green, and blue images from the image sensors 110 into a full-color image 114.

Because red, green, and blue light are split before reaching the image sensors 110, each image sensor 110 only receives, or mostly only receives, one color of light. As such, color filters may be omitted from the image sensors 110. By omitting color filters, the image sensors 110 may have high efficiency and high sensitivity. Because each image sensor 110 is used for only one color (e.g., red, green, or blue), no one image sensor 110 performs full-color imaging. Hence, pixel sensors of the image sensors 110 are smaller than full-color pixel sensors. The smaller pixel sensors lead to higher spatial resolution and enhanced color accuracy.

With continued reference to FIG. 1, the flat lenses 102 are distributed amongst a plurality of transparent substrates 116, which may, for example, be or comprise glass, fused silica, quartz, the like, or any combination of the foregoing. Further, the flat lenses 102 comprise an imaging lens 118, a beam splitter 120, a first beam deflector 122a, and a second beam deflector 122b. As seen hereafter, additional lenses are amenable.

The imaging lens 118 is configured to focus the light 104 into the beam 106 of white light with a focal plane on the image sensors 110. The beam splitter 120 is between the imaging lens 118 and the first beam deflector 122a and between the imaging lens 118 and the second beam deflector 122b. The beam splitter 120 is configured to split the beam 106 into the plurality of sub-beams 108, which include a first sub-beam 108a, a second sub-beam 108b, and a third sub-beam 108c. Further, the beam splitter 120 is configured to direct the first and second sub-beams 108a, 108b respectively to the first and second beam deflectors 122a, 122b, which are on opposite sides of the beam splitter 120.

The beam 106 includes light spanning a range of wavelengths, and the plurality of sub-beams 108 include light spanning different subsets of the range. The range corresponds to visible wavelengths, which may, for example, be about 400-700 nanometers or the like. The different subsets correspond to red, green, and blue wavelengths. Red wavelengths may, for example, be about 625-740 nanometers, about 635 nanometers, or the like. Green wavelengths may, for example, be about 520-565 nanometers, about 520 nanometers, or the like. Blue wavelengths may, for example, be about 350-500 nanometers, about 430 nanometers, or the like.

In some embodiments, the beam 106 is a beam of visible or white light, and the first, second, and third sub-beams 108a-108c are respectively a beam of blue light, a beam of red light, and a beam of green light. In other embodiments, the first, second, and third sub-beams 108a-108c correspond to different colors. For example, the first, second, and third sub-beams 108a-108c may respectively be the beam of red light, the beam of green light, and a beam of blue light

The first and second beam deflectors 122a, 122b are configured to deflect the first and second sub-beams 108a, 108b. For example, the first and second beam deflectors 122a, 122b may deflect the first and second sub-beams 108a, 108b so generally parallel to the third sub-beam 108c. As another example, the first and second beam deflectors 122a, 122b may deflect the first and second sub-beams 108a, 108b so orthogonal to surfaces of corresponding image sensors 110a, 110b that receive the first and second sub-beams 108a, 108b. In some embodiments, the first and second beam deflectors 122a, 122b receive the first and second sub-beams 108a, 108b at oblique angles α. The oblique angles α may, for example, be about 25-35 degrees, about 28 degrees, or some other suitable angle.

In some embodiments, the flat lenses 102 are meta lenses using columnar structures having high refractive indexes and subwavelength sizes and/or spacings to manipulate light. In such embodiments, the flat lenses 102 have different patterns of columnar structures to achieve different functions. For example, the imaging lens 118 may have a different pattern of columnar structures than the beam splitter 120.

The image sensors 110 are separated from the beam splitter 120 by the first and second beam deflectors 122a, 122b. Further, the image sensors 110 are on a sensor substrate 124. The sensor substrate 124 may, for example, be a printed circuit board (PCB), a silicon substrate, a silicon interposer, or the like. The image sensors 110 comprises a first image sensor 110a, a second image sensor 110b, and a third image sensor 110c corresponding to the first, second, and third sub-beams 108a-108c (e.g., with a one-to-one correspondence). The first, second, and third image sensors 110a-110c are configured to receive corresponding sub-beams and to generate individual images from the corresponding sub-beams.

In some embodiments, the first sub-beam 108a, the first beam deflector 122a, and the first image sensor 110a correspond to blue light, the second sub-beam 108b, the second beam deflector 122b, and the second image sensor 110b correspond to red light, and the third sub-beam 108c and the third image sensor 110c correspond to green light. In other embodiments, these red, green, and blue light assignments vary. In some embodiments, the image sensors 110 are CMOS image sensors or some other suitable type of image sensor.

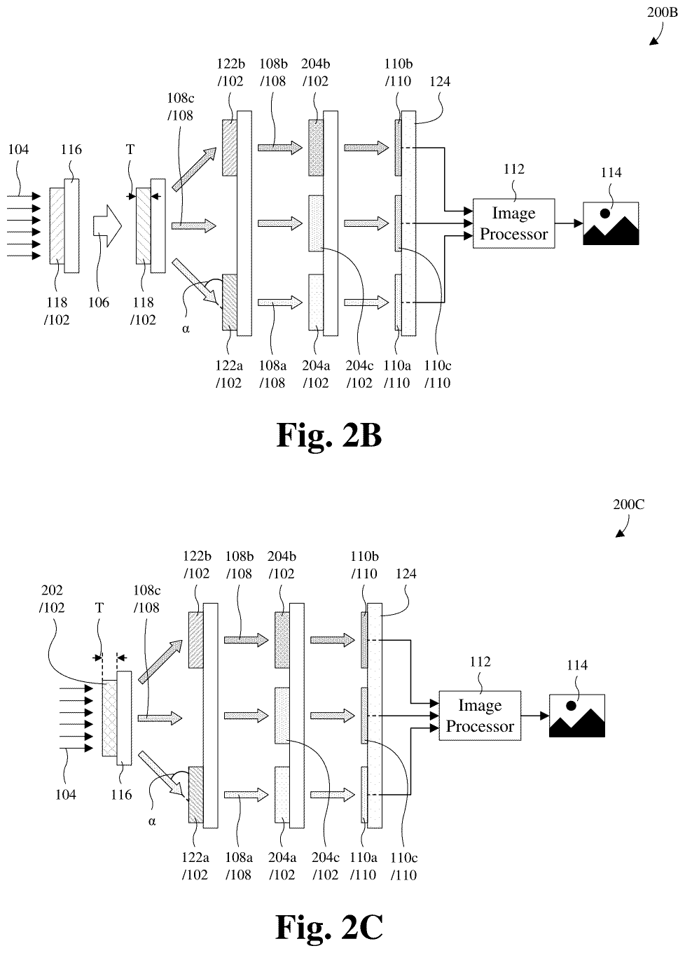

With reference to FIGS. 2A-2C, schematic views 200A-200C of some alternative embodiments of the camera module of FIG. 1 is provided.

In FIG. 2A, the imaging lens 118 and the beam splitter 120 are combined into a composite lens 202. The composite lens 202 is configured to perform both the function of the imaging lens 118 and the function of the beam splitter 120. As noted above, the function of the imaging lens 118 is to focus the light 104, and the function of the beam splitter 120 is to split the light into the sub-beams 108. Combining optical functions into a single lens allows the camera module to reach a smaller size at the cost of lower optical efficiency.

In FIG. 2B, the plurality of flat lenses 102 further comprise a first precise imaging lens 204a, a second precise imaging lens 204b, and a third precise imaging lens 204c (collectively the precise imaging lenses 204a-204c). The precise imaging lenses 204a-204c are on a corresponding one of the transparent substrates 116 and separate the first and second beam deflectors 122a, 122b from the image sensors 110. The first, second, and third precise imaging lenses 204a-204c are configured to focus the first, second, and third sub-beams 108a-108c respectively on the first, second, and third image sensors 110a-110c.

Because each of the precise imaging lenses 204a-204c is used for only one color (e.g., red, green, or blue), the precise imaging lenses 204a-204c are used for only a narrow band of wavelengths or even a single wavelength. This is to be contrasted with the imaging lens 118, which is used for a broad band of wavelengths. At least for flat lens, as is the case here, the optical performance of narrow-band and single-wavelength lenses is better than broad-band lenses. For example, dispersion is more difficult to correct with broad-band lenses, whereby broad-band lenses are more likely to have chromatic aberrations in which different wavelengths have different focal lengths and images are blurred. Hence, the precise imaging lenses have enhanced performance compared to the imaging lens 118 and may address chromatic aberrations. Further, the imaging lens 118 may be regarded as coarse imaging lens 118.

In FIG. 2C, the camera module further comprises the precise imaging lenses 204a-204c of FIG. 2B and the imaging lens 118 and the beam splitter 120 are combined into the composite lens 202 as in FIG. 2A. Combining lenses may counteract the increased thickness the camera module has from the precise imaging lenses 204a-204c.

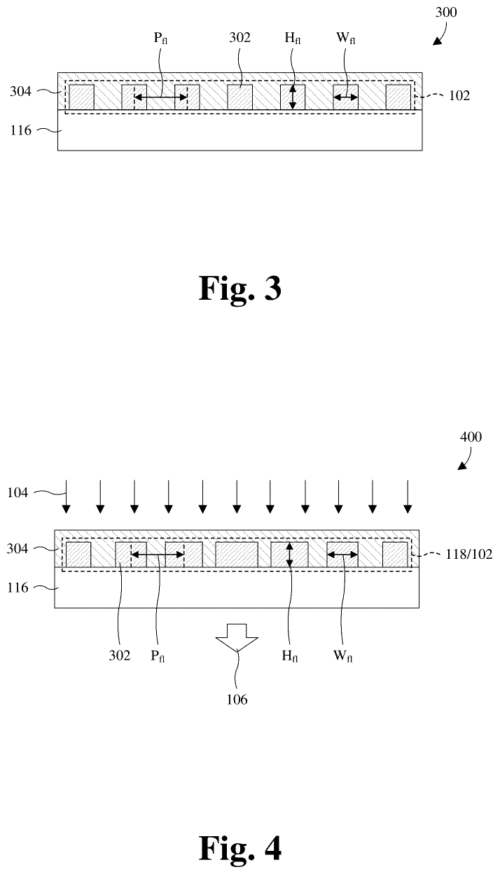

With reference to FIG. 3, a cross-sectional view 300 of some embodiments of a flat lens 102 of FIG. 1 is provided. The flat lens 102 comprises a plurality of columnar structures 302 arranged in a single-layer pattern on a transparent substrate 116 and covered by a protection layer 304. In some embodiments, the columnar structures 302 may also be referred to as nanostructures. The columnar structures 302 form metasurfaces that manipulate light, whereby the flat lens 102 may be regarded as a meta lens. Depending on the pattern of the columnar structures 302, parameters and/or functionality of the flat lens 102 may be varied.

In some embodiments, a pattern of the columnar structures 302 is determined by: 1) dividing the flat lens 102 into a plurality of areas; 2) calculating an optical phase for each area to achieve a desired optical function; 3) determining a library of correlations between columnar structure pattern and optical phase; and 4) for each area, arranging columnar structures according to the columnar structure pattern correlated with the optical phase at that area. Other suitable processes for determining the pattern are, however, amenable.

In some embodiments, the flat lens 102 performs a single optical function. Examples may, for example, include the imaging lens 118, the beam splitter 120, the first beam deflector 122a, and the second beam deflector 122b. In other embodiments, the flat lens 102 performs multiple optical functions. An example may, for example, include the composite lens 202 of FIG. 2A. In some embodiments in which the flat lens 102 performs multiple optical functions, a pattern of columnar structures is determined for each optical function and then the patterns are combined (e.g., spatially multiplexed). In other embodiments in which the flat lens 102 performs multiple optical functions, a single pattern of columnar structures 302 is determined to simultaneously perform each function.

In at least some embodiments, the flat lens 102 is representative of each flat lens 102 of FIGS. 1 and 2A-2C, except for the pattern of the columnar structures 302. For example, the flat lens 102 may be representative of the imaging lens 118, except that the columnar structures 302 may have a different pattern to achieve functionality of the imaging lens 118. As another example, the flat lens 102 may be representative of the beam splitter 120, except that columnar structures 302 may have a different pattern to achieve functionality of the beam splitter 120.

The columnar structures 302 have a high refractive index. In some embodiments, the high refractive index is a refractive index greater than about 2, about 6, or the like and/or is a refractive of about 2-5, about 2-4, about 2-6, or the like. In some embodiments, the high refractive index is a refractive index greater than a refractive index of the transparent substrate 116 and/or greater than a refractive index of the protection layer 304. Further, the columnar structures 302 have a pitch P_{fl}, individual heights H_{fl}, and individual widths W_{fl}.

The pitch P_{fl} is measured from width-wise center to width-wise center of any two neighboring columnar structures. In some embodiments, the pitch P_{fl} is sub-wavelength. A sub-wavelength pitch may, for example, be a pitch less than light wavelengths for which the flat lens 102 is configured. Further, a sub-wavelength pitch may, for example, be a pitch less than about 0.4 micrometers, about 0.2 micrometers, or the like and/or a pitch of about 0.2-0.4 micrometers, about 0.2-0.3 micrometers, about 0.3-0.4 micrometers, or the like.

The heights H_{fl} may, for example, be less than about 3 micrometers, about 1.5 micrometers, about 0.7 micrometers, or the like and/or may, for example, be about 0.1-3.0 micrometers, about 0.1-0.7 micrometers, about 0.7-1.5 micrometers, about 1.5-3.0 micrometers, or the like. In some embodiments, the heights H_{fl} are uniform.

The widths W_{fl} may, for example, be about 0.1-2.0 micrometers, about 0.1-1.0micrometers, about 1.0-2.0 micrometers, or the like. In some embodiments, the widths W_{fl} are sub-wavelength. Similar to a sub-wavelength pitch, a sub-wavelength width may, for example, be a width less than light wavelengths for which the flat lens 102 is configured. Further, a sub-wavelength width may, for example, be a width less than about 0.4 micrometers, about 0.2 micrometers, or the like and/or a width of about 0.2-0.4 micrometers or the like.

In some embodiments, the columnar structures 302 have a low absorption coefficient for light wavelengths for which the flat lens 102 is configured. The low absorption coefficient may, for example, be less than about 1e5 reciprocal centers (cm⁻¹), about 1e4 cm⁻¹, about 1e3 cm⁻¹, or the like, and/or may, for example, be about 1e3-1e5 cm⁻¹ or the like. In some embodiments, the columnar structures 302 are in a periodic pattern.

In some embodiments, the columnar structures 302 are or comprise silicon (e.g., Si), titanium oxide (e.g., TiO₂), gallium nitride (e.g., GaN), aluminum nitride (e.g., AlN), silicon nitride (e.g., SiN), the like, or any combination of the foregoing. In some embodiments, the protection layer 304 is or comprises silicon oxide (e.g., SiO₂) and/or the like.

With reference to FIG. 4, a cross-sectional view 400 of some embodiments of the flat lens 102 of FIG. 3 is provided in which the flat lens 102 is the imaging lens 118. As such, the pattern of the columnar structures 302 is configured to focus light 104 into a beam 106 of light. In some embodiments, the widths W_{fl} of the columnar structures 302 decrease from the width-wise center of the flat lens 102 to the periphery of the flat lens 102.

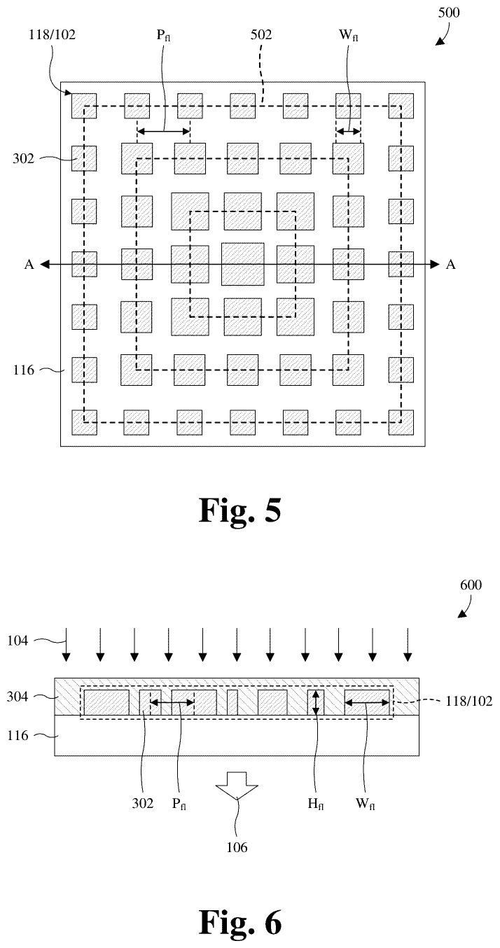

With reference to FIG. 5, a top layout view 500 of some embodiments of the imaging lens 118 of FIG. 4 is provided. The cross-sectional view 400 of FIG. 4 may, for example, be taken along line A-A or along some other suitable line. The columnar structures 302 are arranged in a plurality of ring-shaped paths 502 that are concentric. The columnar structures 302 along a given ring-shaped path share a common size, and the columnar structures 302 decrease in size radially away from a center of the imaging lens 118.

In alternative embodiments, the imaging lens 118 has a plurality of concentric, ring-shaped regions, where each ring-shaped region has an arrangement of columnar structures 302 that increase in diameter radially towards a center of the imaging lens 118. In alternative embodiments, the imaging lens 118 has a periodic pattern of columnar structures 302 that share a common size, where the periodic pattern repeats throughout the imaging lens 118.

With reference to FIG. 6, a cross-sectional view 600 of some alternative embodiments of the imaging lens 118 of FIG. 4 is provided in which a pattern of the columnar structures 302 is varied. For example, the pitch P_{fl} and the widths W_{fl} may vary from the width-wise center of the imaging lens 118 to the periphery of the imaging lens 118.

While the views 400-600 of FIGS. 4-6 illustrate the imaging lens 118 (e.g., of FIG. 1), the views 400-600 of FIGS. 4-6 may be representative of each precise imaging lens 204a-204c (e.g., of FIG. 2B). For example, each precise imaging lens 204a-204c may have a pattern of columnar structures 302 as in FIG. 4, FIG. 5, FIG. 6, or any combination of the foregoing, except that the pitch P_{fl} and the widths W_{fl} may be tuned for the specific wavelength(s).

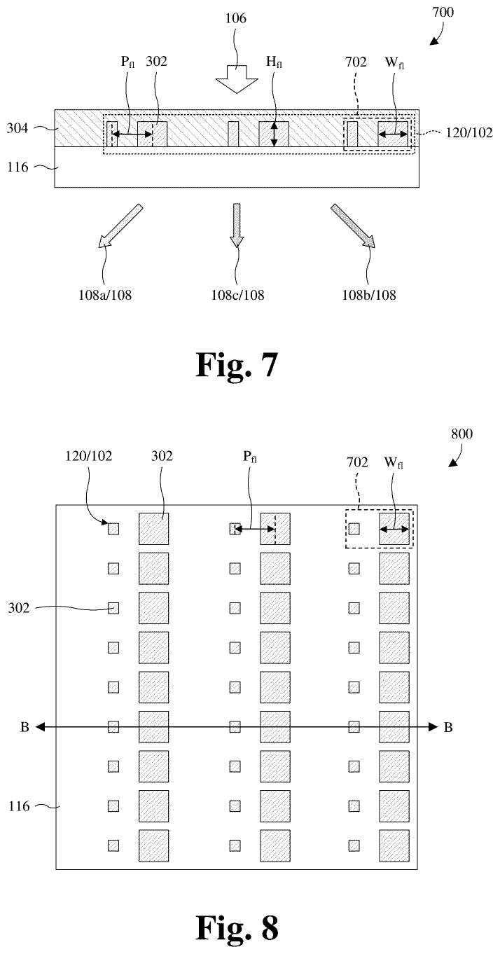

With reference to FIG. 7, a cross-sectional view 700 of some embodiments of the flat lens 102 of FIG. 3 is provided in which the flat lens 102 is the beam splitter 120. As such, the pattern of the columnar structures 302 is configured to split a beam 106 of white or visible light into a plurality of sub-beams 108. Further, the sub-beams 108 correspond to a beam of red light, a beam of green light, and a beam of blue light.

In some embodiments, the columnar structures 302 are grouped into a plurality of groups 702 corresponding to red, green, and blue. The groups 702 have similar group patterns that vary by color (e.g., red, green, or blue) to induce a specific resonance effect for corresponding colors. For example, the pitch P_{fl} and the widths W_{fl} may be varied. Note that the groups 702 are shown as the same for ease of illustration, but are practically different for red, green, and blue. The groups 702 are evenly spaced in a direction (e.g., a left-right direction), from a first side of the beam splitter 120 to a second side of the beam splitter 120 opposite the first side. Further, within each of the groups 702, the columnar structures 302 of that group increase or decrease in width W_{fl} in the direction. In some embodiments, the columnar structures 302 are or comprise silicon nitride or the like, whereas the protection layer 304 is or comprises silicon oxide or the like. Other suitable materials are, however, amenable.

With reference to FIG. 8, a top layout view 800 of some embodiments of the beam splitter 120 of FIG. 7 is provided. The cross-sectional view 700 of FIG. 7 may, for example, be taken along line B-B or along some other suitable line. The groups 702 of columnar structures 302 are arranged in a plurality of rows and a plurality of columns. For example, as illustrated, the groups 702 may be arranged in 9 rows and 3 columns. However, more or less rows and/or more or less columns are amenable in alternative embodiments.

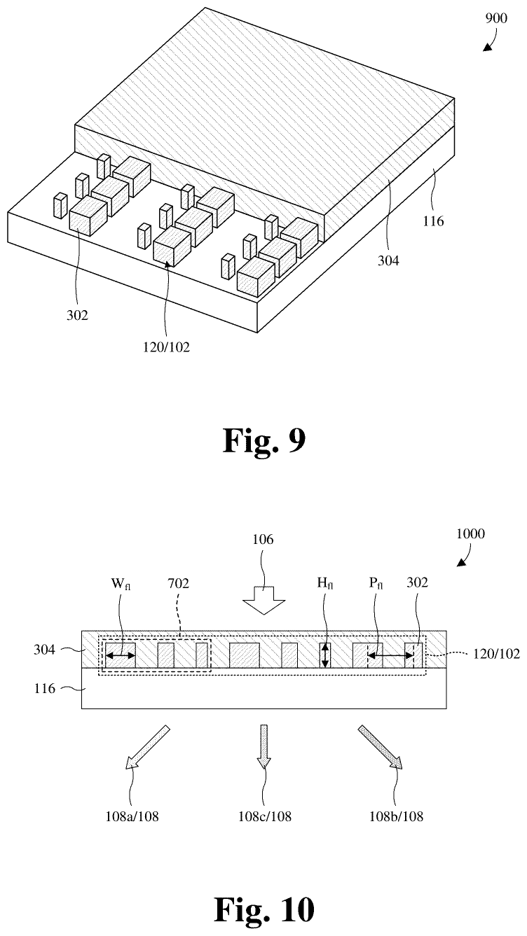

With reference to FIG. 9, a perspective view 900 of some embodiments of the beam splitter 120 of FIGS. 7 and 8 is provided in which the protection layer 304 has a partial cutaway. The partial cutaway allows some of the columnar structures 302 to be viewed.

With reference to FIG. 10, a cross-sectional view 1000 of some alternative embodiments of the beam splitter 120 of FIG. 7 is provided. For example, except for a group at a right side of the beam splitter 120, each group 702 has three columnar structures 302 instead of two columnar structures 302.

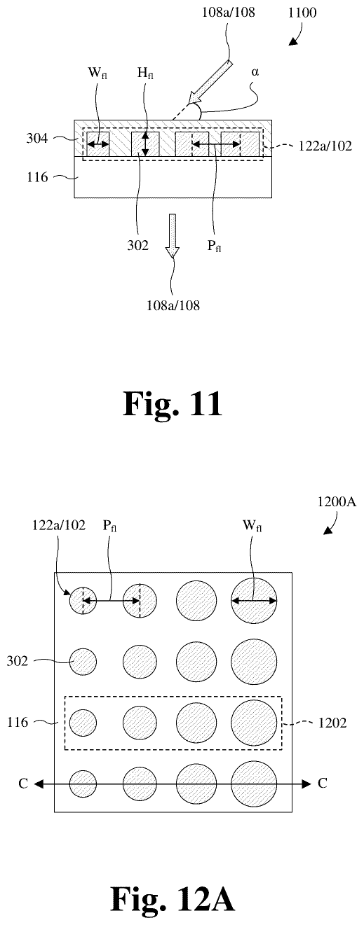

With reference to FIG. 11, a cross-sectional view 1100 of some embodiments of the flat lens 102 of FIG. 3 is provided in which the flat lens 102 is the first beam deflector 122a. As such, the pattern of the columnar structures 302 is configured to deflect the first sub-beam 108a. As noted above, the first sub-beam 108a is deflected so generally parallel to the third sub-beam 108c of FIG. 1 and/or so orthogonal to a surface of the first image sensor 110a. Further, as noted above, the first sub-beam 108a is received at an oblique angle α. The oblique angle α may, for example, be about 28 degrees or the like. In some embodiments, the columnar structures 302 are or comprise titanium oxide or the like, whereas the protection layer 304 is or comprises silicon oxide or the like. Other suitable materials are, however, amenable.

In some embodiments, the pitch P_{fl} of the columnar structures 302 is uniform across a width of the first beam deflector 122a, from a first side (e.g., a left side) of the first beam deflector 122a to a second side (e.g., a right side) of the first beam deflector 122a. Further, in some embodiments, the pitch P_{fl} is about 250 nanometers or some other suitable value. In some embodiments, the width W_{fl} of the columnar structures 302 increases across the width of the first beam deflector 122a, from the first side to the second side. For example, the four illustrated columnar structures 302 may respectively have widths W_{fl} of about 120 nanometers, about 150 nanometers, about 180 nanometers, and about 205 nanometers from the first side to the second side. Other suitable width values are, however, amenable.

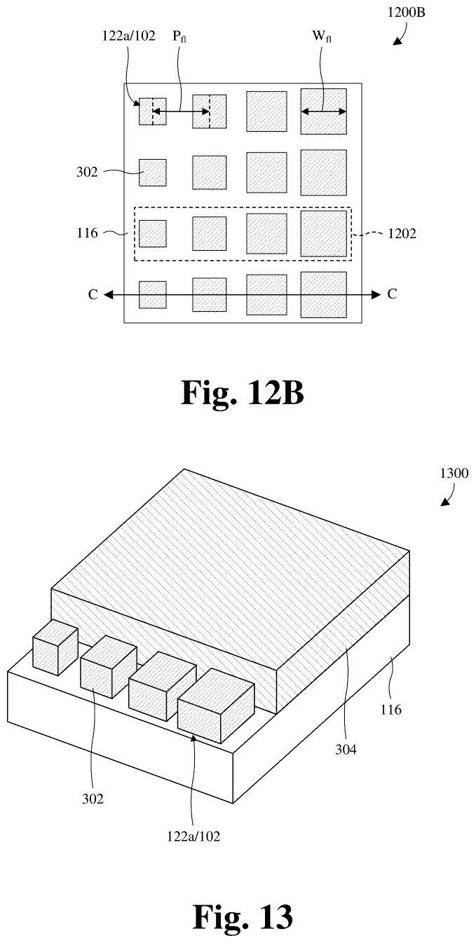

With reference to FIGS. 12A and 12B, top layout views 1200A, 1200B of some embodiments of the first beam deflector 122a of FIG. 11 are provided. The cross-sectional view 1100 of FIG. 11 may, for example, be taken along line C-C or along some other suitable line. In FIG. 12A, the columnar structures 302 have circular top geometries. In FIG. 12B, the columnar structures 302 have square top geometries. In other embodiments, the columnar structures 302 have triangular top geometries or some other suitable top geometries.

In both FIGS. 12A and 12B, the columnar structures 302 are grouped into a plurality of groups 1202. The groups 1202 share a group pattern and are arranged in a column. Further, the groups are evenly spaced in the column. Within each of the groups 1202, the columnar structures 302 of that group increase in width W_{fl} in a row-wise direction, from a left side of the first beam deflector 122a to a right side of the first beam deflector 122a. While four groups 1202 are illustrated, more or less groups are amenable in alternative embodiments.

With reference to FIG. 13, a perspective view 1300 of some embodiments of the first beam deflector 122a of FIGS. 11 and 12B is provided in which the protection layer 304 has a partial cutaway. The partial cutaway allows some of the columnar structures 302 to be viewed.

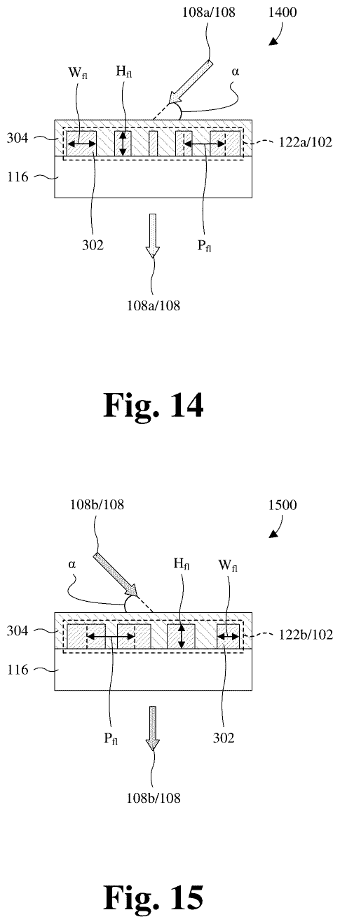

With reference to FIG. 14, a cross-sectional view 1400 of some alternative embodiments of the first beam deflector 122a of FIG. 11 is provided. For example, the pitch P_{fl} and the width W_{fl} both increase from a width-wise center of the first beam deflector 122a to a periphery of the first beam deflector 122a.

While FIGS. 11, 12A, 12B, 13, and 14 have patterns of columnar structures 302 tuned to deflect wavelengths of the first sub-beam 108a, the patterns may be flipped horizontally and tuned to deflect wavelengths of the second sub-beam 108b. For example, with reference to FIG. 15, a cross-sectional view 1500 of some embodiments of the flat lens 102 of FIG. 3 is provided in which the flat lens 102 is the second beam deflector 122b. As such, the pattern of the columnar structures 302 is configured to deflect the second sub-beam 108b. This pattern may be a mirror image of any one or combination of the patterns for the first beam deflector 122a of FIGS. 11, 12A, 12B, and 13, except for the pitch P_{fl} and/or the widths W_{fl} being tuned to deflect the wavelengths of the second sub-beam 108b.

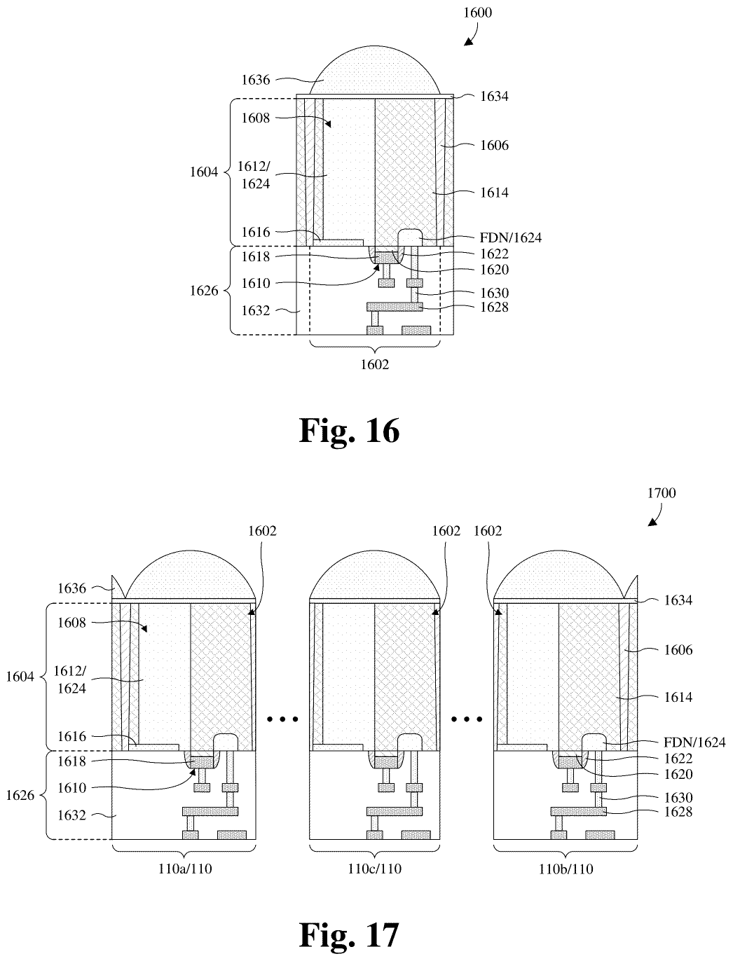

With reference to FIG. 16, a cross-sectional view 1600 of some embodiments of an image sensor 110 of FIG. 1 is provided. The image sensor 110 is representative of each of the first, second, and third image sensors 110a-110c of FIG. 1. Further, the image sensor 110 comprises a pixel sensor 1602 on a semiconductor substrate 1604. The semiconductor substrate 1604 may, for example, be or comprise a bulk substrate of silicon or the like, a silicon-on-insulator (SOI) substrate, or some other suitable type of substrate.

The pixel sensor 1602 is surrounded by a trench isolation structure 1606 extending into the semiconductor substrate 1604. The trench isolation structure 1606 demarcates a boundary of the pixel sensor 1602 in the semiconductor substrate 1604 and separates the pixel sensor 1602 from any neighboring pixel sensors. Further, the trench isolation structure 1606 extends completely through the semiconductor substrate 1604 and is or comprises a high k dielectric and/or some other suitable dielectric(s). In alternative embodiment, the trench isolation structure 1606 extends only partially through the semiconductor substrate 1604. The pixel sensor 1602 comprises a photodetector 1608, a transfer transistor 1610, and additional transistors that are not shown. The pixel sensor 1602 may, for example, be a 4 transistor (4T) active pixel sensor (APS) or some other suitable type of pixel sensor.

The photodetector 1608 comprises a collector region 1612, which has a first doping type and which is surrounded by a doped well 1614 having a second doping type opposite the first doping type. For example, the first doping type may be n-type, and the second doping type may be p-type, or vice versa. Further, the photodetector 1608 comprises a pinning region 1616. The pinning region 1616 has the second doping type and overlaps with the collector region 1612 on a frontside of the semiconductor substrate 1604. The photodetector 1608 may, for example, be or comprise a pinned photodiode or some other suitable photodetector.

The transfer transistors 1610 comprises a gate electrode 1618, a gate dielectric layer 1620, a sidewall spacer 1622, and a pair of source/drain regions 1624. The gate electrode 1618 is stacked with the gate dielectric layer 1620, and the gate dielectric layer 1620 separates the gate electrode 1618 from the semiconductor substrate 1604. The sidewall spacer 1622 is on sidewalls of the gate electrode 1618 and sidewalls of the gate dielectric layer 1620. The source/drain regions 1624 are in the semiconductor substrate 1604, and the gate electrode 1618 is between the source/drain regions 1624. Further, the source/drain regions 1624 correspond to the collector region 1612 and a floating diffusion node FDN. Source/drain region(s) may refer to a source or a drain, individually or collectively dependent upon the context.

An interconnect structure 1626 covers and electrically couples to the transfer transistor 1610 on the frontside of the semiconductor substrate 1604. The interconnect structure 1626 comprise a plurality of wires 1628 and a plurality of vias 1630 in an interconnect dielectric layer 1632. The wires 1628 and the vias 1630 are conductive and are grouped respectively into a plurality of wire levels and a plurality of via levels that are alternatingly stacked to define conductive paths. In some embodiments, the wires 1628 and the vias 1630 are or comprise copper, aluminum, the like, or any combination of the foregoing.

A backside passivation layer 1634 and a micro lens 1636 overlie the semiconductor substrate 1604, on a backside of the semiconductor substrate 1604 opposite the frontside of the semiconductor substrate 1604. The backside passivation layer 1634 is dielectric and transparent to radiation. The micro lens 1636 is separated from the semiconductor substrate 1604 by the backside passivation layer 1634. Further, the micro lens 1636 is configured to focus incident radiation on the photodetector 1608 to enhance quantum efficiency.

With reference to FIG. 17, a cross-sectional view 1700 of some embodiments of a plurality of image sensors is provided in which each image sensor is as in FIG. 16. The plurality of image sensors 110 correspond to the first, second, and third image sensors 110a-110c described above (e.g., with regard to FIG. 1) for blue, red, and green wavelengths. As seen hereafter, 1604 corresponds to a single semiconductor substrate in some embodiments and corresponds to multiple discrete semiconductor substrate in other embodiments.

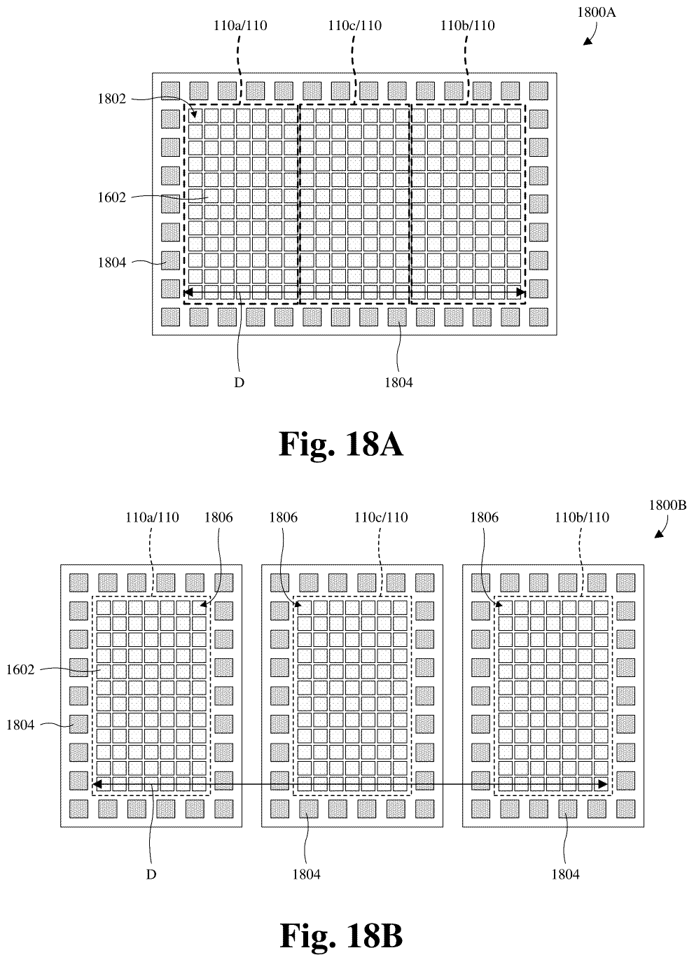

With reference to FIGS. 18A and 18B, top layout views 1800A, 1800B of some embodiments of the plurality of image sensors 110 of FIG. 17 are provided. The cross-sectional view 1700 of FIG. 17 may, for example, be taken along line D-D.

In FIG. 18A, the image sensors 110 are integrated into a common integrated chip and correspond to separate portions of a common pixel array 1802. The pixel array 1802 comprises a plurality of pixel sensors 1602 arranged in a plurality of rows and a plurality of columns. The pixel sensors 1602 are each as in FIG. 16 and share a common semiconductor substrate 1604 (see, e.g., FIG. 17). Hence, photodetectors 1608 (see, e.g., FIG. 17) of the first, second, and third image sensors 110a-110c are in the same semiconductor substrate 1604.

A plurality of pads 1804 are spaced from each other and are arranged along a periphery of the integrated chip in a ring-shaped pattern to surround the common pixel array 1802. The pads 1804 are conductive and provide electrical coupling to the common pixel array 1802 from outside the common integrated chip.

In FIG. 18B, the image sensors 110 are in separate integrated chips and correspond to separate pixel arrays 1806. Each individual pixel array 1806 comprises a plurality of pixel sensors 1602 arranged in a plurality of rows and a plurality of columns. The pixel sensors 1602 are each as in FIG. 16, and the pixel arrays 1806 are on separate semiconductor substrates 1604 (see, e.g., FIG. 17). Hence, photodetectors 1608 (see, e.g., FIG. 17) of the first image sensor 110a are in a first semiconductor substrate, photodetectors 1608 (see, e.g., FIG. 17) of the second image sensor 110b are in a second semiconductor substrate, and photodetectors 1608 (see, e.g., FIG. 17) of the third image sensor 110c are in a third semiconductor substrate, where the first, second, and third semiconductor substrates are different.

A plurality of pads 1804 are spaced from each other and are arranged along peripheries of the integrated chips in ring-shaped patterns to individually surround the pixel arrays 1806. The pads 1804 are conductive and provide electrical coupling to pixel arrays 1806 from outside the integrated chips.

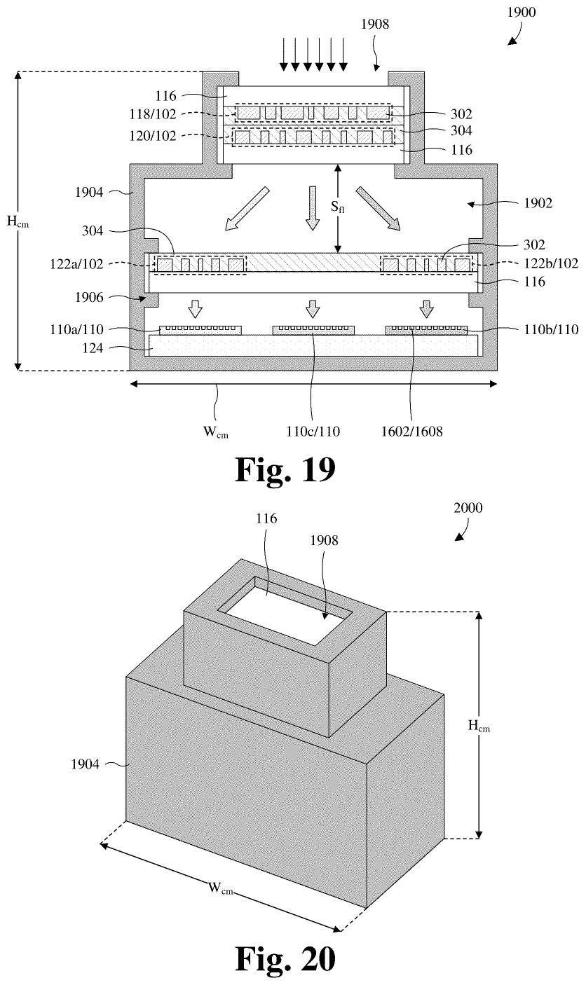

With reference to FIG. 19, a cross-sectional view 1900 of some embodiments of the camera module of FIG. 1 is provided. The flat lenses 102 and the image sensors 110 are arranged in a cavity 1902 defined by a housing 1904. Further, the flat lenses 102 and the image sensors 110 are secured to the housing 1904 with adhesive and/or sidewall protrusions 1906. The image sensors 110 are secured to a bottom surface of the cavity 1902 with an adhesive, and the flat lenses 102 are stacked over the image sensors 110 and secured to the housing 1904 with the sidewall protrusions 1906 and, in some embodiments, an adhesive.

The imaging lens 118 and the beam splitter 120 are at a top of the housing 1904. The imaging lens 118 is on an underside of a corresponding one of the transparent substrates 116 and receives light through an aperture 1908 in the housing 1904. The imaging lens 118 may, for example, be as illustrated and described with regard to FIG. 6, other than being vertically flipped. In alternative embodiments, the imaging lens 118 is as illustrated and described with regard to FIG. 4 and/or FIG. 5. The beam splitter 120 underlies the imaging lens 118, and the protection layer 304 of the beam splitter 120 directly contacts the protection layer 304 of the imaging lens 118. The beam splitter 120 may, for example, be as illustrated and described with regard to FIG. 10. In alternative embodiments, the beam splitter 120 is as illustrated and described with regard to FIG. 7, FIG. 8, FIG. 9, or any combination of the foregoing.

The first and second beam deflectors 122a, 122b underlie the beam splitter 120, respectively on opposite sides of the beam splitter 120. Further, the first and second beam deflectors 122a, 122b are spaced from the beam splitter 120 by a spacing S_{fl}. The spacing S_{fl} may, for example, be about 3 millimeters, about 2.5-3.5 millimeters, or the like. If the spacing S_{fl} is too small (e.g., less than 2.5 millimeters), the sub-beams may partially overlap and color separation may be poor. As a result, the images formed by the image sensors 110 may have poor quality. If the spacing S_{fl} is too large (e.g., less than 3.5 millimeters), the first and second beam deflectors 122a, 122b may fail to properly deflect corresponding sub-beams.

The first beam deflector 122a may, for example, be as illustrated and described with regard to FIG. 14. In alternative embodiments, the first beam deflector 122a is as illustrated and described with regard to FIG. 11, FIG. 12A, FIG. 12B, FIG. 13, or any combination of the foregoing. In some embodiments, the second beam deflector 122b is as the first beam deflector 122a is illustrated and described. In some embodiments, the second beam deflector 122b is a mirror image of the first beam deflector 122a. In some embodiments, the second beam deflector 122b is as illustrated and described with regard to FIG. 15.

The first and second image sensors 110a, 110b respectively underlie the first and second beam deflectors 122a, 122b, and the third image sensor 110c is between the first and second image sensors 110a, 110b. The first, second, and third image sensors 110a-110c each comprise a plurality of pixel sensors 1602, and the pixel sensors 1602 comprise individual photodetectors 1608. For case of illustration, the pixel sensors 1602 and the photodetectors 1608 are schematically illustrated together as white blocks overlaid on the image sensors 110. The pixel sensors 1602 may, for example, each be as illustrated and described with regard to FIG. 16. The image sensors 110 may, for example, each be as illustrated and described with regard to FIG. 16, FIG. 17, FIG. 18A, FIG. 18B, or any combination of the foregoing.

In some embodiments, the image sensors 110 are integrated into a common integrated chip as in FIGS. 17 and 18A. In other embodiments, the image sensors 110 are integrated into separate integrated chips as in FIGS. 17 and 18B.

The housing 1904 has a width W_{cm} and a height H_{cm}. The width W_{cm} may, for example, be less than about 20 millimeters, about 15 millimeters, about 10 millimeters, or the like and/or may, for example, be about 10-20 millimeters, about 10-15 millimeters, about 15-20 millimeters, or the like. The height H_{cm} may, for example, be less than about 5 millimeters, about 4 millimeters, 3 millimeters, 2 millimeters, or the like and/or may, for example, be about 4-5 millimeters, about 3-4 millimeters, about 2-3 millimeters, or the like. As described above, because of use of flat lenses, the height H_{cm} may be small and camera bumps may be omitted or reduced in size on cell phones and the like incorporating the camera module.

With reference to FIG. 20, a perspective view 2000 of some embodiments of the camera module of FIG. 19 is provided.

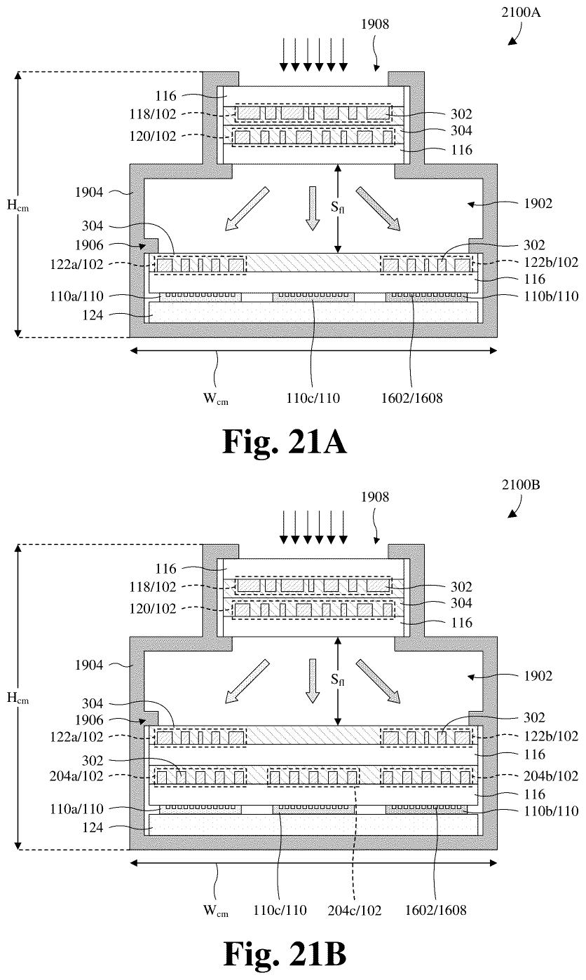

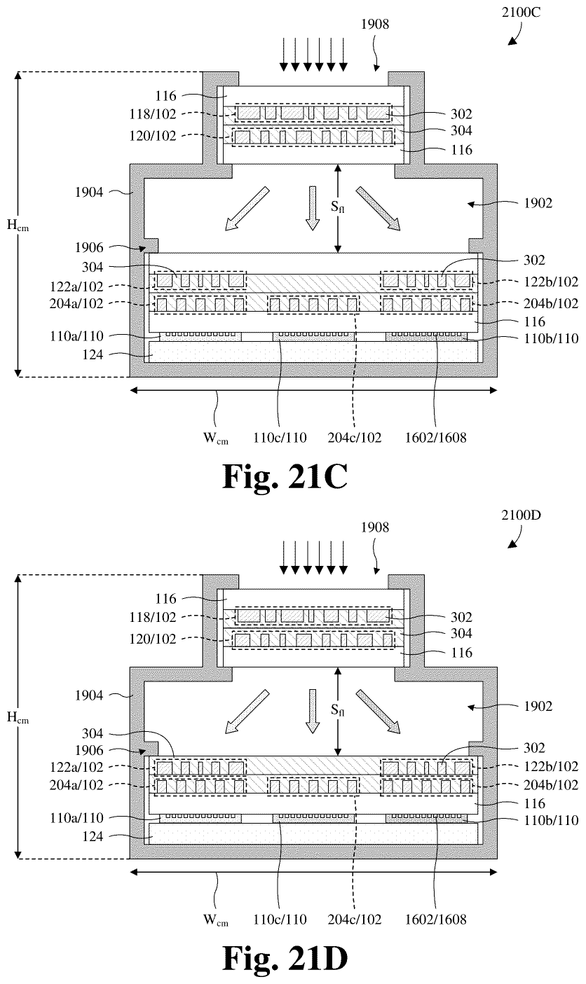

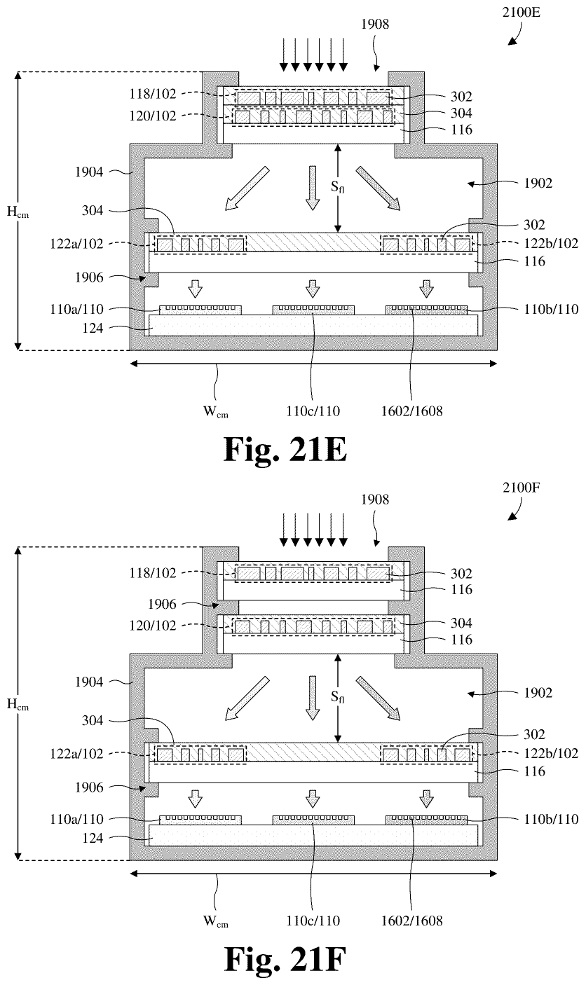

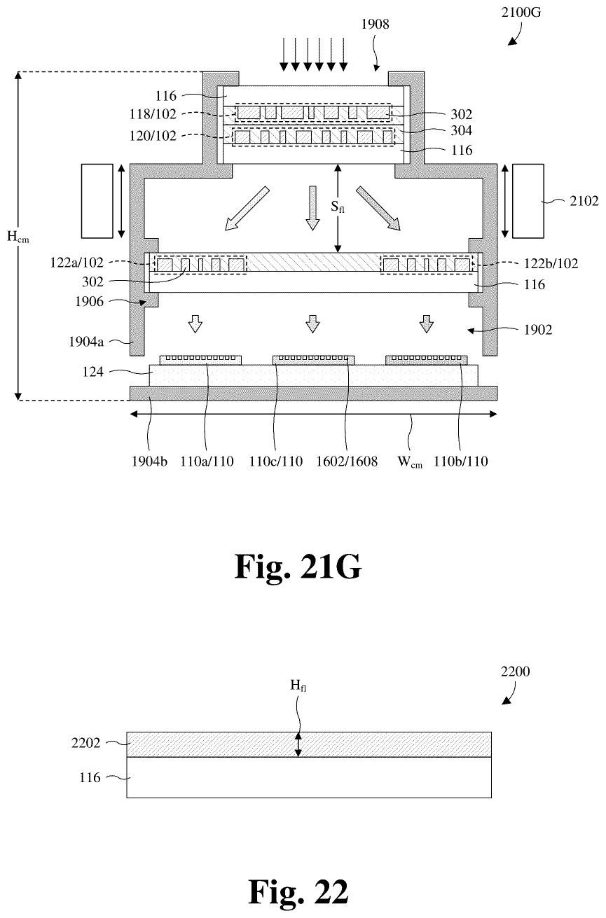

With reference to FIGS. 21A-21G, cross-sectional views 2100A-2100G of some alternative embodiments of the camera module of FIG. 19 are provided.

In FIG. 21A, the space separating the first and second beam deflectors 122a, 122b from the image sensors 110 is removed. As such, the transparent substrate 116 of the first and second beam deflectors 122a, 122b directly contacts the image sensors 110.

In FIG. 21B, a first precise imaging lens 204a, a second precise imaging lens 204b, and a third precise imaging lens 204c (collectively the precise imaging lenses 204a-204c) respectively overlie the first, second, and third image sensors 204a-204c. Further, the precise imaging lenses 204a-204c are on the same transparent substrate 116, between the first and second beam deflectors 122a, 122b and the image sensors 110. Each of the precise imaging lenses 204a-204c is as the flat lens 102 of FIG. 3 is illustrated and described, except that the columnar structures 302 have patterns configured to focus corresponding sub-beams respectively on the image sensors 110 as described with regard to FIG. 2B.

In FIG. 21C, the camera module is as in FIG. 21B, except that the first and second beam deflectors 122a, 122b are on an underside of a corresponding one of the transparent substrates 116. As such, the protection layer 304 of the first and second beam deflectors 122a, 122b directly contacts the protection layer 304 of the precise imaging lenses 204a-204c.

In FIG. 21D, the camera module is as in FIG. 21B, except that the precise imaging lenses 204a-204c share a transparent substrate 116 with the first and second beam deflectors 122a, 122b. As a result, there is no transparent substrate separating the precise imaging lenses 204a-204c from the first and second beam deflectors 122a, 122b. This reduces the height H_{cm} of the housing 1904, whereby the camera module may be small and camera bumps may be omitted or reduced in size on cell phones and the like incorporating the camera module.

In FIG. 21E, the imaging lens 118 and the beam splitter 120 share a transparent substrate 116 instead of having individual transparent substrates. As a result, there is one less transparent substrate and the height H_{cm} of the housing 1904 is reduced. Because the height H_{cm} is reduced, the camera module may be small and camera bumps may be omitted or reduced in size on cell phones and the like incorporating the camera module.

In FIG. 21F, the imaging lens 118 is separated from the beam splitter 120 by a corresponding one of the transparent substrates 116, which is spaced from the beam splitter 120.

In FIG. 21G, the housing 1904 is split into an upper housing 1904a and a lower housing 1904b. The lower housing 1904b accommodates the image sensors 110, whereas the upper housing 1904a accommodates the flat lenses 102. Further, a voice coil motor (VCM) 2102 surrounds the upper housing 1904a and is configured to move the upper housing 1904a and hence the flat lenses 102 vertically (e.g., up and down) relative to the image sensors 110. Such movement may, for example, enhance focusing and improve image quality.

With reference to FIGS. 22-24, a series of cross-sectional views 2200-2400 of some embodiments of a method for forming a single-layer optical structure comprising a flat lens is provided. The flat lens may, for example, correspond to the flat lens 102 of FIG. 3.

As illustrated by the cross-sectional view 2200 of FIG. 22, an optical layer 2202 is deposited on a transparent substrate 116. The transparent substrate 116 may, for example, be or comprise glass, fused silica, quartz, the like, or any combination of the foregoing. Further, the transparent substrate 116 may, for example, be a 2, 3, 5, or 6 inch wafer or the like. The deposition may, for example, be performed by vapor deposition, atomic layer deposition (ALD), the like, or any combination of the foregoing.

The optical layer 2202 has a high refractive index. In some embodiments, the high refractive index is a refractive index greater than about 2, about 6, or the like and/or is a refractive of about 2-5, about 2-4, about 2-6, or the like. In some embodiments, the high refractive index is a refractive index greater than a refractive index of the transparent substrate 116. In some embodiments, the optical layer 2202 has a low absorption coefficient for light wavelengths for which the single-element optical structure is configured. The low absorption coefficient may, for example, be less than about 1e5 cm⁻¹, about 1e4 cm⁻¹, about 1e3 cm⁻¹, or the like. In some embodiments, the optical layer 2202 is or comprises silicon (e.g., Si), titanium oxide (e.g., TiO₂), gallium nitride (e.g., GaN), aluminum nitride (e.g., AlN), silicon nitride (e.g., SiN), the like, or any combination of the foregoing.

In some embodiments, a height H_{fl} of the optical layer 2202 may, for example, be less than about 3 micrometers, about 1.5 micrometers, about 0.7 micrometers, or the like and/or may, for example, be about 0.1-3.0 micrometers, about 0.1-0.7 micrometers, about 0.7-1.5 micrometers, about 1.5-3.0 micrometers, or the like.

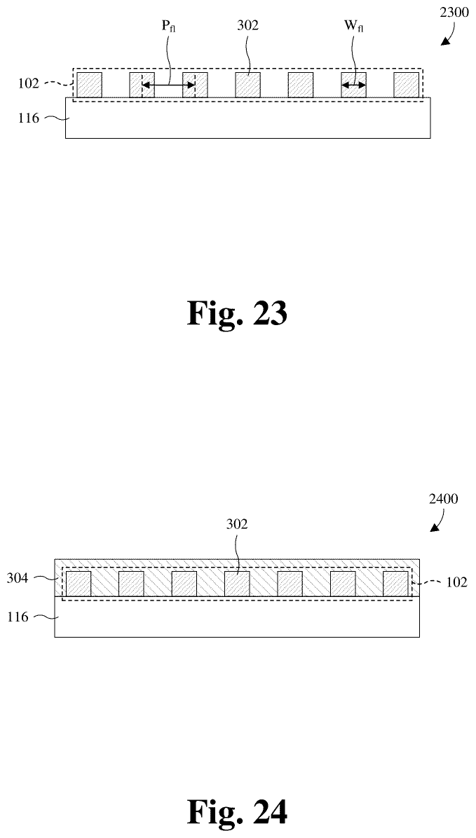

As illustrated by the cross-sectional view 2300 of FIG. 23, the optical layer 2202 is patterned to form a plurality of columnar structures 302. The patterning may, for example, be performed by a photolithography/etching process or some other suitable patterning process.

The columnar structures 302 form a flat lens 102 and further form metasurfaces that manipulate light, whereby the flat lens 102 may be regarded as a meta lens. Depending on the pattern of the columnar structures 302, parameters and/or functionality of the flat lens 102 may be varied. The pattern is generically illustrated but may be as in any one or combination of FIGS. 4-11, 12A, 12B, and 13-15 to form the flat lens 102 as the imaging lens 118, the beam splitter 120, the first beam deflector 122a, the second beam deflector 122b, or some other lens.

The columnar structures 302 have a pitch P_{fl} and individual widths W_{fl}. The pitch P_{fl} is measured from width-wise center to width-wise center of any two neighboring columnar structures. In some embodiments, the pitch P_{fl} is sub-wavelength. A sub-wavelength pitch may, for example, be a pitch less than light wavelengths for which the flat lens 102 is configured. Further, a sub-wavelength pitch may, for example, be a pitch less than about 0.4 micrometers, about 0.2 micrometers, or the like and/or a pitch of about 0.2-0.4 micrometers, about 0.2-0.3 micrometers, about 0.3-0.4 micrometers, or the like. In some embodiments, the pitch P_{fl} is uniform from a width-wise center of the flat lens 102 to a periphery of the flat lens 102.

The widths W_{fl} may, for example, be about 0.1-2.0 micrometers, about 0.1-1.0 micrometers, about 1.0-2.0 micrometers, or the like. In some embodiments, the widths W_{fl} are sub-wavelength. A sub-wavelength width may, for example, be a width less than light wavelengths for which the flat lens 102 is configured. Further, a sub-wavelength width may, for example, be a width less than about 0.4 micrometers, about 0.2 micrometers, or the like and/or a width of about 0.2-0.4 micrometers or the like.

As illustrated by the cross-sectional view 2400 of FIG. 24, a protection layer 304 is deposited over the columnar structures 302. The deposition may, for example, be performed by vapor deposition, ALD, the like, or any combination of the foregoing. The protection layer 304 is transmissive of light and may, for example, be or comprise silicon oxide (e.g., SiO₂), the like, or any combination of the foregoing.

Also illustrated by the cross-sectional view 2400 of FIG. 24, a planarization is performed into a top of the protection layer 304 to flatten the top of the protection layer 304. The planarization may, for example, be performed by a chemical mechanical polish (CMP) or some other suitable type of planarization.

While FIGS. 22-24 are described with reference to a method, it will be appreciated that the structures shown in these figures are not limited to the method but rather may stand alone separate of the method. While FIGS. 22-24 are described as a series of acts, it will be appreciated that the order of the acts may be altered in other embodiments. While FIGS. 22-24 illustrate and describe as a specific set of acts, some acts that are illustrated and/or described may be omitted in other embodiments. Further, acts that are not illustrated and/or described may be included in other embodiments.

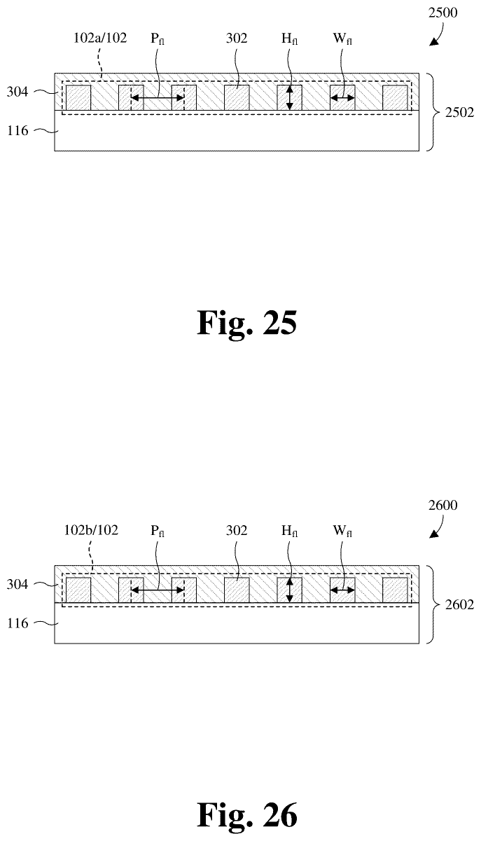

With reference to FIGS. 25-27, a series of cross-sectional views 2500-2700 of some first embodiments of a method for forming a multi-layer optical structure comprising flat lenses is provided.

As illustrated by the cross-sectional view 2500 of FIG. 25, a first single-layer optical structure 2502 is formed as described with regard to FIGS. 22-24. The first single-layer optical structure 2502 comprises a first flat lens 102a.

As illustrated by the cross-sectional view 2600 of FIG. 26, a second single-layer optical structure 2602 is formed as described with regard to FIGS. 22-24. The second single-layer optical structure 2602 comprises a second flat lens 102b.

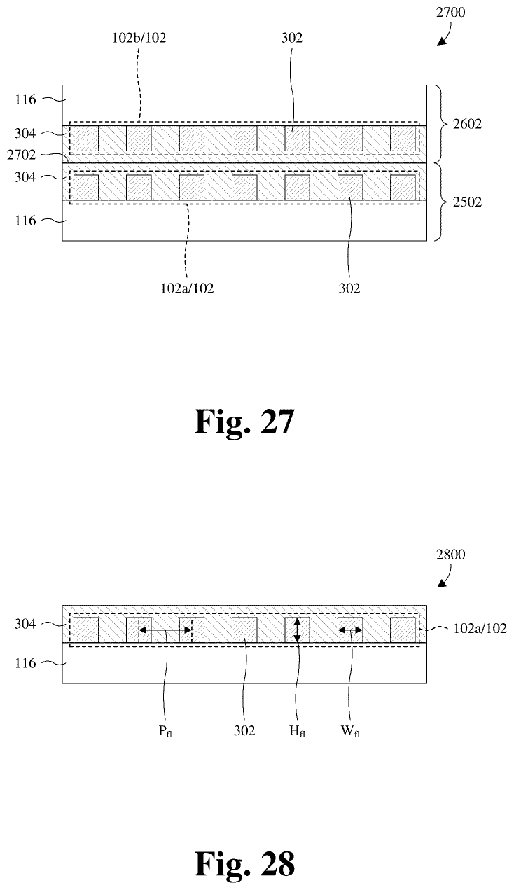

As illustrated by the cross-sectional view 2700 of FIG. 27, the second single-layer optical structure 2602 of FIG. 26 is vertically flipped and bonded to the first single-layer optical structure 2502 of FIG. 25, such that the flat lenses 102 are between the transparent substrates 116. The bonding occurs at an interface 2702 at which the protection layers 304 directly contact and may, for example, be performed by fusion bonding, direct bonding, the like, or any combination of the foregoing.

Also illustrated by the cross-sectional view 2700 of FIG. 27, the interface 2702 is baked or annealed to strengthen the interface 2702. In some embodiments, additional processing is subsequently performed. The additional processing may, for example, comprising thinning down one or both of the transparent substrates 116, depositing an antireflective coating (ARC) on one or both of the transparent substrates 116, or some other suitable processing.

Note that the columnar structures 302 of the flat lenses 102 are formed with generic patterns for explanatory purposes. However, in practice, the columnar structures 302 of the first flat lens 102a have a different pattern than the columnar structures 302 of the second flat lens 102b so the first and second flat lenses 102a, 102b perform different functions.

In some embodiments, the first flat lens 102a is a beam splitter and the second flat lens 102b is an imaging lens or vice versa. FIGS. 19, 21A-21D, and 21G provide non-limiting examples of the resulting multi-layer optical structure. The imaging lens may, for example, correspond to the imaging lens 118 in FIG. 4, FIG. 5, FIG. 6, or any combination of the foregoing. The beam splitter may, for example, correspond to the beam splitter 120 in FIG. 7, FIG. 8, FIG. 9, FIG. 10, or any combination of the foregoing.

In other embodiments, the first flat lens 102a is a precise imaging lens and the second flat lens 102b is a beam deflector. FIG. 21C provides a non-limiting example of the resulting multi-layer optical structure. The beam deflector may, for example, correspond to the first or second beam deflector 122a, 122b in FIG. 11, FIG. 12A, FIG. 12B, FIG. 13, FIG. 14, FIG. 15, or any combination of the foregoing. The precise imaging lens may, for example, correspond to a precise imaging lens 204a-204c in FIG. 21B.

While FIGS. 25-27 are described with reference to a method, it will be appreciated that the structures shown in these figures are not limited to the method but rather may stand alone separate of the method. While FIGS. 25-27 are described as a series of acts, it will be appreciated that the order of the acts may be altered in other embodiments. While FIGS. 25-27 illustrate and describe as a specific set of acts, some acts that are illustrated and/or described may be omitted in other embodiments. Further, acts that are not illustrated and/or described may be included in other embodiments.

With reference to FIGS. 28-31, a series of cross-sectional views 2800-3100 of some second embodiments of a method for forming a multi-layer optical structure comprising flat lenses is provided. In contrast with the first embodiments of FIGS. 25-27, the multiple layers are on a single transparent substrate instead of separate transparent substrates.

As illustrated by the cross-sectional view 2800 of FIG. 28, the acts described with regard to FIGS. 22-24 are performed to form a first flat lens 102a on a transparent substrate 116. Thereafter, the acts described with regard to FIGS. 22-24 are repeated on the protection layer 304 to form a second flat lens 102b above the first flat lens 102a.

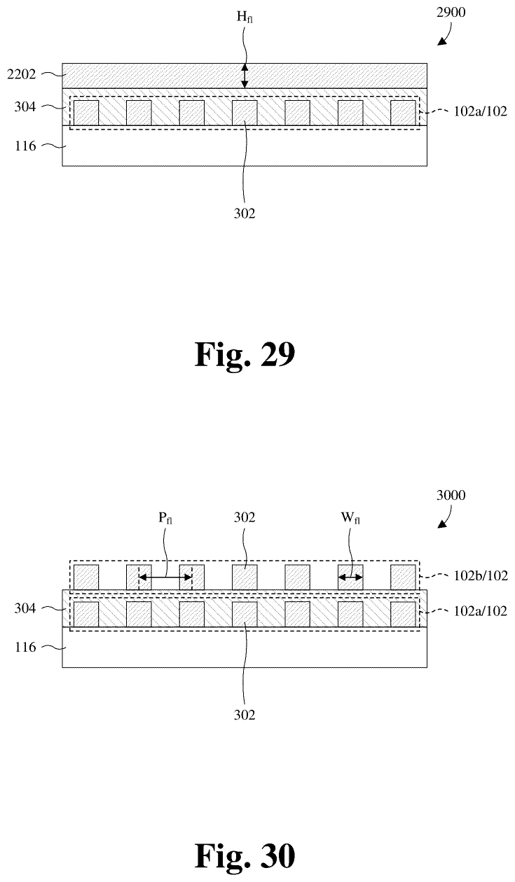

As illustrated by the cross-sectional view 2900 of FIG. 29, an optical layer 2202 is deposited on the protection layer 304 as described with regard to FIG. 22.

As illustrated by the cross-sectional view 3000 of FIG. 30, the optical layer 2202 is patterned to form a plurality of columnar structures 302 forming a second flat lens 102b. The patterning is performed as described with regard to FIG. 23.

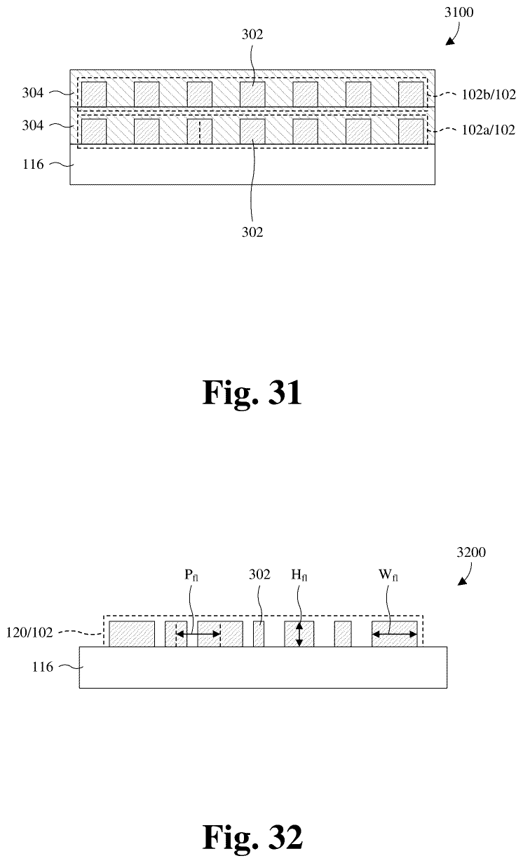

As illustrated the cross-sectional view 3100 of FIG. 31, a protection layer 304 is deposited covering the second flat lens 102b, and a planarization is performed into a top of the protection layer 304, as described with regard to FIG. 24.

Note that the columnar structures 302 of the flat lenses 102 are formed with generic patterns for explanatory purposes. However, in practice, the columnar structures 302 of the first flat lens 102a have a different pattern than the columnar structures 302 of the second flat lens 102b so the first and second flat lenses 102a, 102b perform different functions.

In some embodiments, the first flat lens 102a is a beam splitter and the second flat lens 102b is an imaging lens or vice versa. FIGS. 19 and 21A-21D provide non-limiting examples of the resulting multi-layer optical structure. The imaging lens may, for example, correspond to the imaging lens 118 in FIG. 4, FIG. 5, FIG. 6, or any combination of the foregoing. The beam splitter may, for example, correspond to the beam splitter 120 in FIG. 7, FIG. 8, FIG. 9, FIG. 10, or any combination of the foregoing.

In other embodiments, the first flat lens 102a is a precise imaging lens and the second flat lens 102b is a beam deflector. FIG. 21C provides a non-limiting example of the resulting multi-layer optical structure. The beam deflector may, for example, correspond to the first or second beam deflector 122a, 122b in FIG. 11, FIG. 12A, FIG. 12B, FIG. 13, FIG. 14, FIG. 15, or any combination of the foregoing. The precise imaging lens may, for example, correspond to a precise imaging lens 204a-204c in FIG. 21B.

While FIGS. 28-31 are described with reference to a method, it will be appreciated that the structures shown in these figures are not limited to the method but rather may stand alone separate of the method. While FIGS. 28-31 are described as a series of acts, it will be appreciated that the order of the acts may be altered in other embodiments. While FIGS. 28-31 illustrate and describe as a specific set of acts, some acts that are illustrated and/or described may be omitted in other embodiments. Further, acts that are not illustrated and/or described may be included in other embodiments.

With reference to FIGS. 32-44, a series of cross-sectional views 3200-4400 of some embodiments of a method for forming a camera module comprising flat lenses is provided. The camera module may, for example, correspond to the camera module of FIG. 21D.

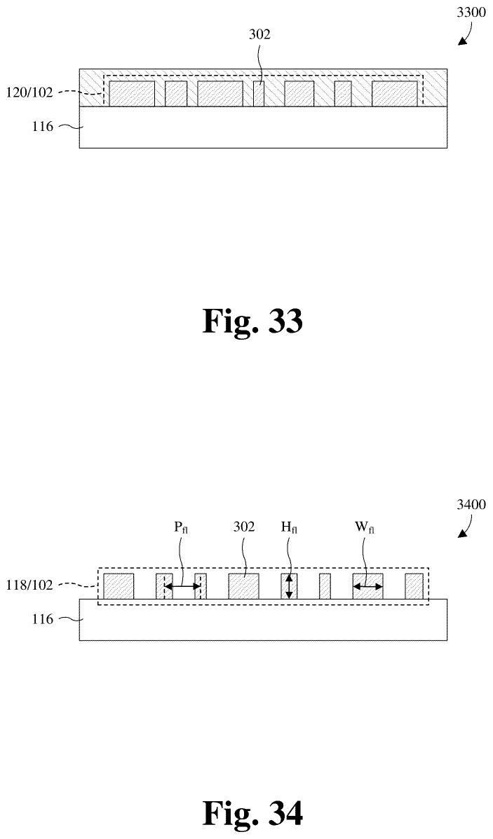

As illustrated by the cross-sectional views 3200, 3300 of FIGS. 32 and 33, a beam splitter 120 is formed on a transparent substrate 116 according to the method of FIGS. 22-24. The beam splitter 120 is configured to split a beam of visible or white light into sub-beams of red, green, and blue light. Focusing on FIG. 32, an optical layer is deposited on the transparent substrate 116 and is subsequently patterned to form the beam splitter 120 according to the acts described with regard to FIGS. 22 and 23. Focusing on FIG. 33, a protection layer 304 is formed covering the beam splitter 120 according to the acts described with regard to FIG. 24.

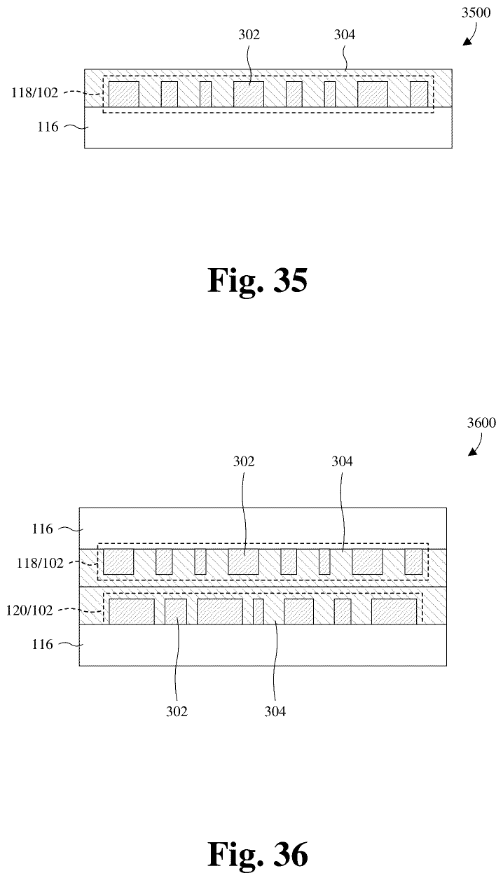

As illustrated by the cross-sectional views 3400, 3500 of FIGS. 34 and 35, an imaging lens 118 is formed on a transparent substrate 116 according to the method of FIGS. 22-24. The imaging lens 118 is configured to focus visible or white light into a beam of visible or white light. Focusing on FIG. 34, an optical layer 2202 is deposited on the transparent substrate 116 and is subsequently patterned to form the imaging lens 118 according to the acts described with regard to FIGS. 22 and 23. Focusing on FIG. 35, a protection layer 304 is formed covering the imaging lens 118 according to the acts described with regard to FIG. 24.

As illustrated by the cross-sectional view 3600 of FIG. 36, the structure of FIG. 35 is vertically flipped and bonded to the structure of FIG. 33. As a result, the individual protection layers 304 of the imaging lens 118 and the beam splitter 120 directly contact. The bonding may, for example, be performed by fusion bonding, direct bonding, the like, or any combination of the foregoing. As should be appreciated, the method illustrated by FIGS. 32-36 may, for example, be regarded as embodiments of the method of FIGS. 25-27 in which the first and second flat lenses 102a, 102b are respectively the beam splitter 120 and the imaging lens 118.

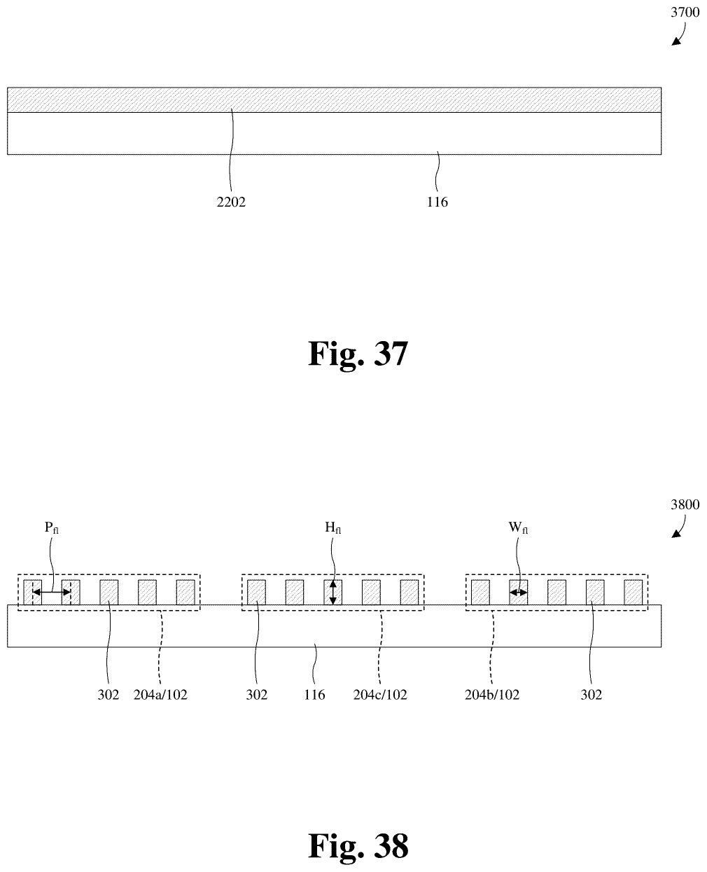

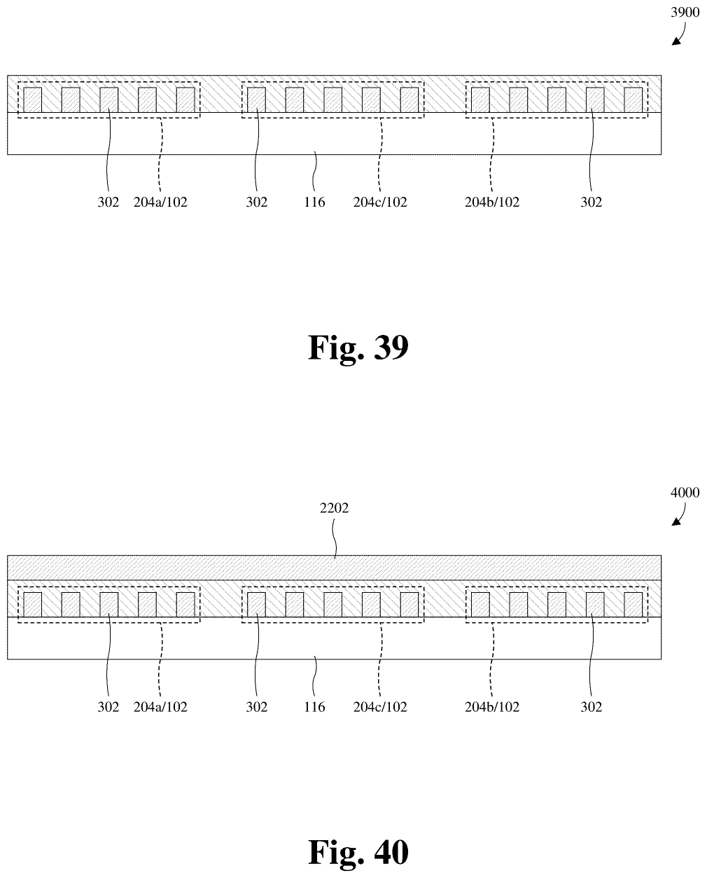

As illustrated by the cross-sectional views 3700-3900 of FIGS. 37-39, a first precise imaging lens 204a, a second precise imaging lens 204b, and a third precise imaging lens 204c (collectively the precise imaging lenses 204a-204c) are concurrently formed on a transparent substrate 116 according to the method of FIGS. 22-24. The precise imaging lenses 204a-204c are configured to focus corresponding sub-beams of light onto corresponding image sensors. Focusing on FIG. 37, an optical layer 2202 is deposited on a transparent substrate 116 according to the acts described with regard to FIG. 22. Focusing on FIG. 38, the optical layer 2202 is patterned to form the precise imaging lenses 204a-204c according to the acts described with regard to FIG. 23. Focusing on FIG. 39, a protection layer 304 is formed covering the precise imaging lenses 204a-204c according to the acts described with regard to FIG. 24.

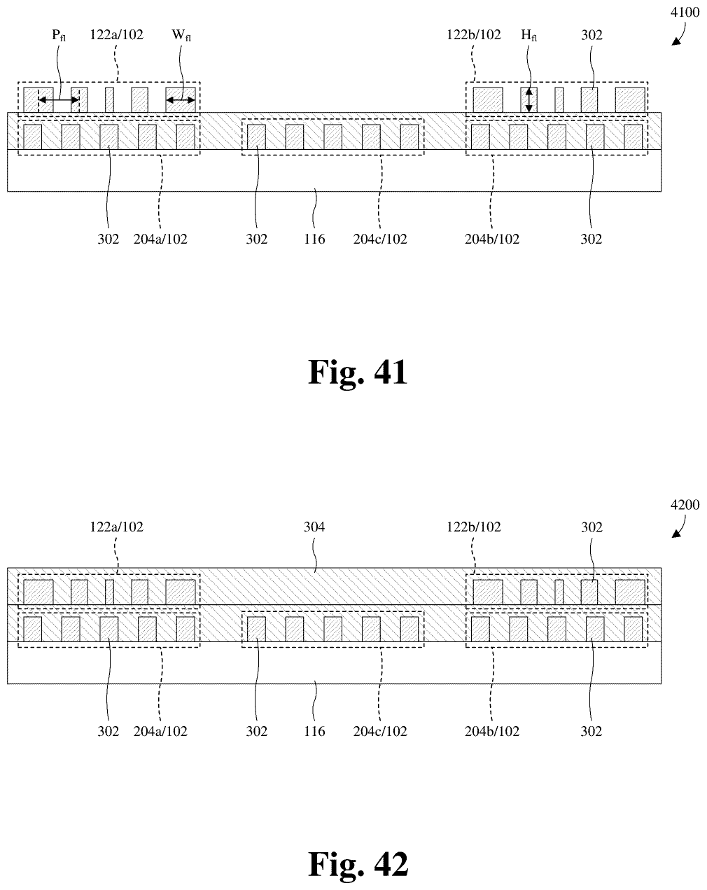

As illustrated by the cross-sectional views 4000-4200 of FIGS. 40-42, a first beam deflector 122a and a second beam deflector 122b are concurrently formed on the protection layer 304 according to the method of FIGS. 22-24. The first and second beam deflectors 122a, 122b are configured to deflect corresponding sub-beams of light towards corresponding image sensors and respectively overlie the first and second precise imaging lenses 204a, 204b. Focusing on FIG. 40, an optical layer 2202 is deposited on the protection layer 304 according to the acts described with regard to FIG. 22. Focusing on FIG. 41, the optical layer 2202 is patterned to form the first and second beam deflectors 122a, 122b according to the acts described with regard to FIG. 23. Focusing on FIG. 42, another protection layer 304 is formed covering the first and second beam deflectors 122a, 122b according to the acts described with regard to FIG. 24.

As should be appreciated, the method illustrated by FIGS. 37-42 may, for example, be regarded as embodiments of the method of FIGS. 28-31 in which the first and second flat lenses 102a, 102b are respectively one of the first, second, and third precise imaging lens 204a-204c and one of the first and second beam deflectors 122a, 122b.

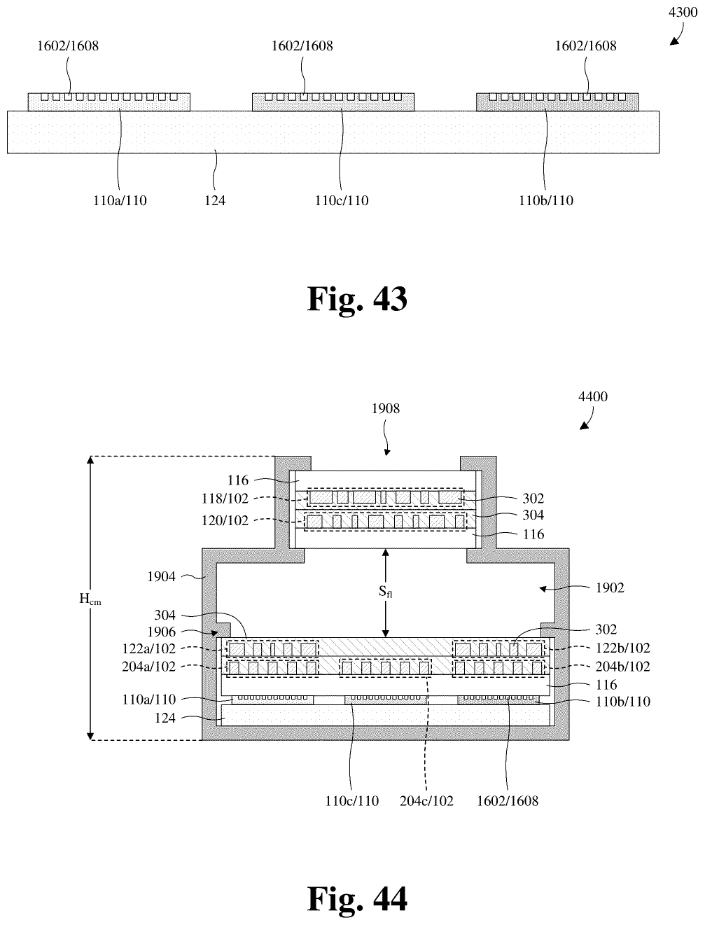

As illustrated by the cross-sectional view 4300 of FIG. 43, a plurality of image sensors 110 are formed and subsequently bonded to a sensor substrate 124 shared by the image sensors 110. The sensor substrate 124 may, for example, be a PCB, a silicon substrate, a silicon interposer, or the like.

The plurality of image sensors 110 correspond to red, green, and blue sub-beams of light and comprises a first image sensor 110a, a second image sensor 110b, and a third image sensor 110c. The first, second, and third image sensors 110a-110c each comprises a plurality of pixel sensors 1602, and the pixel sensors 1602 comprise individual photodetectors 1608. For case of illustration, the pixel sensors 1602 and the photodetectors 1608 are schematically illustrated together as white blocks overlaid on the image sensors 110. The pixel sensors 1602 may, for example, each be as illustrated and described with regard to FIG. 16. The image sensors 110 may, for example, be CMOS image sensors and/or may, for example, each be as illustrated and described with regard to FIG. 16, FIG. 17, FIG. 18A, 18B, or any combination of the foregoing.

As illustrated by the cross-sectional view 4400 of FIG. 44, the structure of FIG. 36, the structure FIG. 42, and the structure of FIG. 43 are arranged in a cavity 1902 defined by a housing 1904. Said structures may, for example, be secured to the housing 1904 by adhesive and/or sidewall protrusions 1906 of the housing 1904.

The structure of FIG. 36, which includes the imaging lens 118 and the beam splitter 120, is arranged at a top of the housing 1904 at an aperture 1908 in the housing 1904. The structure of FIG. 43, which includes the image sensors 110, is arranged at a bottom of the housing 1904. The structure of FIG. 42, which includes the precise imaging lenses 204a-204c and the first and second beam deflectors 122a, 122b, is arranged between the image sensors 110 and the beam splitter 120. The first and second beam deflectors 122a, 122b respectively overlie the first and second precise imaging lenses 204a, 204b, which respectively overlie the first and second image sensors 110a, 110b. The third precise imaging lens 204c respectively overlies the third image sensor 110c. Further, the structure of FIG. 42 is spaced from the transparent substrate 116 of the beam splitter 120 by a spacing S_{fl} and directly contacts the image sensors 110. In alternative embodiments, the image sensors 110 are spaced from the structure of FIG. 42.

As seen above, the camera module uses flat lenses instead of curved, refractive lenses. Flat lenses have reduced heights (or thicknesses) compared to curved, refractive lenses performing the same optical functions. As such, by using flat lenses, the camera module may have a reduced height H_{cm} (or thickness). Because of the reduced height H_{cm}, camera bumps may be omitted or reduced in size on cell phones and the like incorporating the camera module. The reduced height H_{cm} may, for example, be less than about 5 or the like.

Additionally, as seen above, the flat lenses 102 may be formed by wafer-level, semiconductor manufacturing processes, which reduces costs compared to manufacturing processes for curved, refractive lenses.

During use of the camera module, the imaging lenses 118 focus visible or white light into a beam of light, which is split into red, green, and blue sub-beams by the beam splitter 120. The first and second beam deflectors 122a, 122b receive two of the sub-beams at oblique angles and deflect these sub-beams towards the first and second image sensors 110a, 110b. The precise imaging lenses 204a-204c focus the sub-beams on the image sensors 110, which generate red, green, and blue images that are combined into a full-color image.

Because red, green, and blue light are split before reaching the image sensors 110, each image sensor 110 only receives, or mostly only receives, one color of light. As such, color filters may be omitted from the image sensors 110. By omitting color filters, the image sensors 110 may have high efficiency and high sensitivity. Because each image sensor 110 is used for only one color (e.g., red, green, or blue), no one image sensor 110 performs full-color imaging. Hence, pixel sensors of the image sensors 110 are smaller than full-color pixel sensors. The smaller pixel sensors lead to higher spatial resolution and enhanced color accuracy.

While FIGS. 32-44 are described with reference to a method, it will be appreciated that the structures shown in these figures are not limited to the method but rather may stand alone separate of the method. While FIGS. 32-44 are described as a series of acts, it will be appreciated that the order of the acts may be altered in other embodiments. While FIGS. 32-44 illustrate and describe as a specific set of acts, some acts that are illustrated and/or described may be omitted in other embodiments. Further, acts that are not illustrated and/or described may be included in other embodiments.

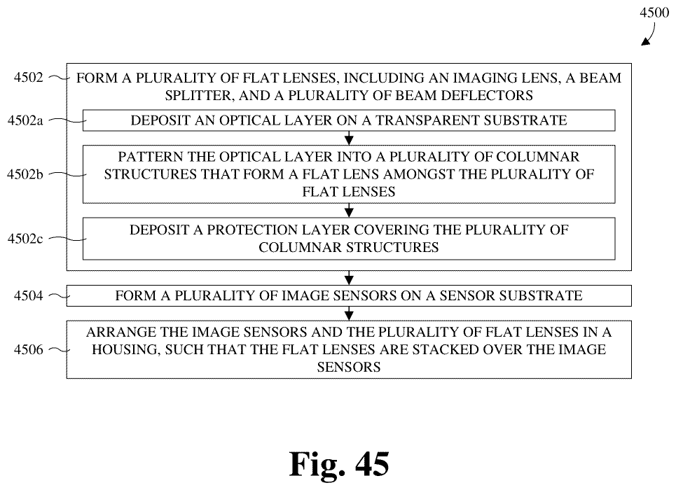

With reference to FIG. 45, a block diagram 4500 of some embodiments of the method of FIGS. 32-44 is provided.

At 4502, a plurality of flat lenses, including an imaging lens, a beam splitter, and a plurality of beam deflectors, is formed. Sec, for example, FIGS. 32-42. At 4502a, an optical layer is deposited on a transparent substrate. See, for example, FIG. 32. At 4502b, the optical layer is patterned into a plurality of columnar structures that form a flat lens amongst the plurality of flat lenses. See, for example, FIG. 32. At 4502c, a protection layer is deposited covering the plurality of columnar structures. See, for example, FIG. 33.

At 4504, a plurality of image sensors is formed on a sensor substrate. See, for example, FIG. 43.

At 4506, the image sensors and the plurality of flat lenses are arranged in a housing, such that the flat lenses are stacked over the image sensors. See, for example, FIG. 44.

While the block diagram 4500 of FIG. 45 is illustrated and described herein as a series of acts or events, it will be appreciated that the illustrated ordering of such acts or events is not to be interpreted in a limiting sense. For example, some acts may occur in different orders and/or concurrently with other acts or events apart from those illustrated and/or described herein. Further, not all illustrated acts may be required to implement one or more aspects or embodiments of the description herein, and one or more of the acts depicted herein may be carried out in one or more separate acts and/or phases.

In some embodiments, the present disclosure provides a camera module, including: a plurality of pixel sensors, including a first pixel sensor, a second pixel sensor, and a third pixel sensor between and spaced from the first and second pixel sensors; an imaging lens over the plurality of pixel sensors; a beam splitter between the imaging lens and the plurality of pixel sensors; and a pair of beam deflectors between the beam splitter and the plurality of pixel sensors, wherein the beam deflectors respectively overlie the first and second pixel sensors; wherein the imaging lens, the beam splitter, and the beam deflectors have flat top profiles and flat bottom profiles. In some embodiments, the imaging lens, the beam splitter, and the beam deflectors are meta lenses. In some embodiments, the imaging lens is configured to focus visible light into a beam of white light, wherein the beam splitter is configured to split the beam into a red sub-beam, a green sub-beam, and a blue sub-beam, and wherein the beam deflectors are configured to deflect two beams amongst the red, green, and blue sub-beams respectively to the first and second pixel sensors. In some embodiments, the camera module further includes a transparent substrate on which the beam deflectors are on, wherein the transparent substrate directly contacts the plurality of pixel sensors and the pair of beam deflectors. In some embodiments, the camera module further includes a plurality of precise imaging lenses between the pair of beam deflectors and the plurality of pixel sensors, wherein the precise imaging lenses respectively overlie the pixel sensors and are configured to focus light respectively on the pixel sensors. In some embodiments, the camera module further includes: a first transparent substrate on which the beam deflectors are on; and a second transparent substrate on which the precise imaging lenses are on, wherein the precise imaging lenses are between the first and second transparent substrates. In some embodiments, the pixel sensors include individual photodetectors in a common semiconductor substrate.

In some embodiments, the present disclosure provides another camera module includes: a plurality of image sensors, including a first image sensor, a second image sensor, and a third image sensor between and spaced from the first and second image sensors; and a plurality of flat lenses stacked over the plurality of image sensors, wherein the flat lenses each includes a plurality of columnar structures, and wherein the flat lenses have different optical functions and different patterns of the columnar structures to achieve the different optical functions. In some embodiments, each of the flat lenses includes the plurality of columnar structures in a single layer on a transparent substrate and with a pattern to achieve a corresponding one of the different optical functions. In some embodiments, the columnar structures of the plurality of flat lenses have refractive indexes in excess of 2. In some embodiments, the camera module further includes a plurality of protection layers respectively covering the columnar structures of the plurality of flat lenses and having low refractive indexes relative to the columnar structures. In some embodiments, the plurality of flat lenses includes a first flat lens and a second flat lens, wherein the camera module includes: a first transparent substrate and a second transparent substrate between which the first and second flat lenses are arranged; and a protection layer separating the first and second flat lenses and extending from the first transparent substrate to the second transparent substrate. In some embodiments, the plurality of flat lenses includes a first flat lens and a second flat lens, wherein the camera module includes: a transparent substrate; a first protection layer overlying the transparent substrate and within which the columnar structures of the first flat lens are arranged; and a second protection layer overlying and directly contacting the first protection layer, wherein the columnar structures of the second flat lens are in the second protection layer and spaced from the columnar structures of the first flat lens by the first protection layer. In some embodiments, the plurality of flat lenses includes a flat lens configured to split light incident on the flat lens into a red, green, and blue light beam.

In some embodiments, the present disclosure provides a method for forming a camera module, the method including: forming a plurality of image sensors, including a first image sensor, a second image sensor, and a third image sensor, on a sensor substrate, wherein the third image sensor is between and spaced from the first and second image sensors; forming a plurality of flat lenses, wherein the forming of the plurality of flat lenses includes: depositing a first optical layer on a first transparent substrate; patterning the first optical layer to form a plurality of columnar structures, which form a first flat lens amongst the plurality of flat lenses; and depositing a first protection layer on the plurality of columnar structures; and arranging the plurality of image sensors and the plurality of flat lenses in a housing, such that the flat lenses are stacked over the plurality of image sensors; wherein the plurality of flat lenses includes an imaging lens, a beam splitter, and a pair of beam deflectors. In some embodiments, the forming of the plurality of flat lenses further includes: depositing a second optical layer on a second transparent substrate; patterning the second optical layer to form a second plurality of columnar structures, which form a second flat lens amongst the plurality of flat lenses; and depositing a second protection layer on the second plurality of columnar structures. In some embodiments, the forming of the plurality of flat lenses further includes bonding the second flat lens to the first flat lens, such that the first and second protection layers directly contact. In some embodiments, the first flat lens is the imaging lens and is configured to focus visible light into a beam of white light, wherein the second flat lens is the beam splitter and is configured to split the beam of white light into a sub-beam of red light, a sub-beam of blue light, and sub-beam of green light. In some embodiments, the forming of the plurality of flat lenses further includes: depositing a second optical layer on the first protection layer; patterning the second optical layer to form a second plurality of columnar structures overlying the first flat lens, wherein the second plurality of columnar structures forms a second flat lens amongst the plurality of flat lenses; and depositing a second protection layer on the second plurality of columnar structures. In some embodiments, the plurality of flat lenses further includes a plurality of precise imaging lenses, wherein the first flat lens is one of the beam deflectors and is configured to deflect a sub-beam to one of the precise imaging lenses, and wherein the second flat lens is the one of the precise imaging lenses and is configured to focus the sub-beam on a corresponding one of the image sensors.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A camera module, comprising:
a plurality of pixel sensors, including a first pixel sensor, a second pixel sensor, and a third pixel sensor between and spaced from the first and second pixel sensors;
an imaging lens over the plurality of pixel sensors;
a beam splitter between the imaging lens and the plurality of pixel sensors; and
a pair of beam deflectors between the beam splitter and the plurality of pixel sensors, wherein the beam deflectors respectively overlie the first and second pixel sensors;
wherein the imaging lens, the beam splitter, and the beam deflectors have flat top profiles and flat bottom profiles.

2. The camera module according to claim 1, wherein the imaging lens, the beam splitter, and the beam deflectors are meta lenses.

3. The camera module according to claim 1, wherein the imaging lens is configured to focus visible light into a beam of white light, wherein the beam splitter is configured to split the beam into a red sub-beam, a green sub-beam, and a blue sub-beam, and wherein the beam deflectors are configured to deflect two beams amongst the red, green, and blue sub-beams respectively to the first and second pixel sensors.

4. The camera module according to claim 1, further comprising:
a transparent substrate on which the beam deflectors are on, wherein the transparent substrate directly contacts the plurality of pixel sensors and the pair of beam deflectors.

5. The camera module according to claim 1, further comprising:
a plurality of precise imaging lenses between the pair of beam deflectors and the plurality of pixel sensors, wherein the precise imaging lenses respectively overlie the pixel sensors and are configured to focus light respectively on the pixel sensors.

6. The camera module according to claim 5, further comprising:
a first transparent substrate on which the beam deflectors are on; and
a second transparent substrate on which the precise imaging lenses are on, wherein the precise imaging lenses are between the first and second transparent substrates.

7. The camera module according to claim 1, wherein the pixel sensors comprise individual photodetectors in a common semiconductor substrate.

8. A camera module, comprising:
a plurality of image sensors, including a first image sensor, a second image sensor, and a third image sensor between and spaced from the first and second image sensors; and
a plurality of flat lenses stacked over the plurality of image sensors, wherein the flat lenses each comprises a plurality of columnar structures, and wherein the flat lenses have different optical functions and different patterns of the columnar structures to achieve the different optical functions.

9. The camera module according to claim 8, wherein each of the flat lenses comprises the plurality of columnar structures in a single layer on a transparent substrate and with a pattern to achieve a corresponding one of the different optical functions.

10. The camera module according to claim 8, wherein the columnar structures of the plurality of flat lenses have refractive indexes in excess of 2.

11. The camera module according to claim 8, further comprising:
a plurality of protection layers respectively covering the columnar structures of the plurality of flat lenses and having low refractive indexes relative to the columnar structures.

12. The camera module according to claim 8, wherein the plurality of flat lenses comprises a first flat lens and a second flat lens, and wherein the camera module comprises:
a first transparent substrate and a second transparent substrate between which the first and second flat lenses are arranged; and
a protection layer separating the first and second flat lenses and extending from the first transparent substrate to the second transparent substrate.

13. The camera module according to claim 8, wherein the plurality of flat lenses comprises a first flat lens and a second flat lens, and wherein the camera module comprises:
a transparent substrate;
a first protection layer overlying the transparent substrate and within which the columnar structures of the first flat lens are arranged; and
a second protection layer overlying and directly contacting the first protection layer, wherein the columnar structures of the second flat lens are in the second protection layer and spaced from the columnar structures of the first flat lens by the first protection layer.

14. The camera module according to claim 8, wherein the plurality of flat lenses comprises a flat lens configured to split light incident on the flat lens into a red, green, and blue light beam.

15. A method for forming a camera module, the method comprising:
forming a plurality of image sensors, including a first image sensor, a second image sensor, and a third image sensor;
forming a plurality of flat lenses, wherein the forming of the plurality of flat lenses comprises:
depositing a first optical layer on a first transparent substrate;
patterning the first optical layer to form a plurality of columnar structures, which form a first flat lens amongst the plurality of flat lenses; and
depositing a first protection layer on the plurality of columnar structures; and
arranging the plurality of image sensors and the plurality of flat lenses in a housing, such that the flat lenses are stacked over the plurality of image sensors and the third image sensor is between and spaced from the first and second image sensors;
wherein the plurality of flat lenses comprises an imaging lens, a beam splitter, and a pair of beam deflectors.

16. The method according to claim 15, wherein the forming of the plurality of flat lenses further comprises:
depositing a second optical layer on a second transparent substrate;
patterning the second optical layer to form a second plurality of columnar structures, which form a second flat lens amongst the plurality of flat lenses; and
depositing a second protection layer on the second plurality of columnar structures.

17. The method according to claim 16, wherein the forming of the plurality of flat lenses further comprises:
bonding the second flat lens to the first flat lens, such that the first and second protection layers directly contact.

18. The method according to claim 16, wherein the first flat lens is the imaging lens and is configured to focus visible light into a beam of white light, and wherein the second flat lens is the beam splitter and is configured to split the beam of white light into a sub-beam of red light, a sub-beam of blue light, and sub-beam of green light.

19. The method according to claim 15, wherein the forming of the plurality of flat lenses further comprises:
depositing a second optical layer on the first protection layer;
patterning the second optical layer to form a second plurality of columnar structures overlying the first flat lens, wherein the second plurality of columnar structures forms a second flat lens amongst the plurality of flat lenses; and
depositing a second protection layer on the second plurality of columnar structures.

20. The method according to claim 19, wherein the plurality of flat lenses further comprises a plurality of precise imaging lenses, wherein the first flat lens is one of the beam deflectors and is configured to deflect a sub-beam to one of the precise imaging lenses, and wherein the second flat lens is the one of the precise imaging lenses and is configured to focus the sub-beam on a corresponding one of the image sensors.
